(19) United States
(12) Patent Application Publication
(10) Pub. No.: US 2025/0323534 A1
(43) Pub. Date: Oct. 16, 2025

(54) REMOVABLE ACCESSORY

(71) Applicant: Apple Inc., Cupertino, CA (US)

(72) Inventors: Jean-Marc PADOVA, San Francisco, CA (US); Aurelien P. RABOISSON, San Diego, CA (US); Dennis D. CONWAY, San Jose, CA (US); Kanuganti Rajeswar REDDY, Castro Valley, CA (US); Li LI, Los Altos, CA (US); Ngabin S. NG, San Diego, CA (US); Viswanath NAGARAJAN, San Jose, CA (US)

(21) Appl. No.: 19/171,892

(22) Filed: Apr. 7, 2025

Related U.S. Application Data
(60) Provisional application No. 63/633,414, filed on Apr. 12, 2024.

(51) Int. Cl. H02J 50/80; G06K 19/07; H02J 7/00; H02J 50/10

(52) U.S. Cl. CPC H02J 50/80; G06K 19/0703; G06K 19/071; G06K 19/0715; H02J 7/00045; H02J 50/10; H02J 2207/30

(57) ABSTRACT

The embodiments described herein regard removable accessories for a wireless device. A removable accessory for a wireless device can include hardware and a power charging capability to allow the wireless device to use functions of the removable accessory and to wirelessly charge the removable accessory. The removable accessory can be charged wirelessly directly from the wireless device or from an external wireless charging pad. The removable accessory can be configured to coordinate shared wireless charging from an external wireless charging pad to allow charging for both the wireless device and the removable accessory.

### CROSS-REFERENCE TO RELATED APPLICATIONS

The present application claims the benefit of U.S. Provisional Application No. 63/633,414, entitled “REMOVABLE PHYSICAL SIM CARD ACCESSORY,” filed Apr. 12, 2024, the content of which is incorporated by reference herein in its entirety for all purposes.

### FIELD

The embodiments described herein regard removable accessories for a wireless device, including removable physical subscriber identity module (pSIM) card accessories for a wireless device. A removable accessory for a wireless device can include hardware and a power charging capability to allow the wireless device to use functions of the removable accessory and to wirelessly charge the removable accessory. In a representative example, the wireless device does not include a slot or tray for holding pSIMs, and the wireless device can connect with and use a pSIM in the removable accessory to communicate with a cellular wireless network.

### BACKGROUND

Many wireless devices are configured to use removable Universal Integrated Circuit Cards (UICCs) that enable the wireless devices to access services provided by Mobile Network Operators (MNOs). In particular, each UICC includes at least a microprocessor and a read-only memory (ROM), where the ROM is configured to store an MNO profile that the wireless device can use to register and interact with an MNO to obtain wireless services via a cellular wireless network. A profile may also be referred to as subscriber identity module (SIM). Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. In fact, wireless devices that exclude physical SIM card trays are starting to appear in the marketplace. Some MNOs and some geographic regions or specific counties may still rely on the use of pSIM card. In addition, some wireless device users can prefer to supplement eSIM use with a pSIM card in some cases. Logistical distribution of new, used, renewed, and/or refurbished eSIM only devices can be limited by a need for support of pSIM cards with the eSIM only devices in some places or for some people. There exists a need for a removable case or accessory that allows use of a pSIM card with an eSIM only device.

### SUMMARY

This Application describes removable accessories for a wireless device, including removable physical subscriber identity module (pSIM) card accessories for a wireless device. A removable accessory for a wireless device, such as a removable case, can include hardware and a power charging capability to allow the wireless device to use functions of the accessory and to wirelessly charge the removable accessory. In a representative example, the wireless device does not include a slot or tray for holding pSIMs, and the wireless device can connect with and use the pSIM in the removable accessory to communicate with a cellular wireless network.

A wireless device can include an embedded universal integrated circuit card (eUICC) on which electronic SIMs (eSIMs) can be loaded and used for communicating with one or more cellular wireless networks. A removable accessory can be coupled to, and in some embodiments powered by, a wireless device and can be used to provide additional functionality to the wireless device. The wireless device, in some embodiments, can exclude a pSIM slot and/or tray in which to install a pSIM card. An external, removable accessory, such as a case or a stand-alone wallet, can include a pSIM slot and/or tray in which to install one or more pSIMs and to couple to the wireless device, which can be an eSIM only wireless device. The removable pSIM card accessory can support use one or more pSIMs with the wireless device. The removable pSIM card accessory can attach to the wireless device, e.g., as a physical snap-on case or as a magnetically attached case, in some embodiments. A removable pSIM card accessory can pair with and connect to the wireless device via a wireless connection (or via a wired connection in some instances). A baseband processor of the wireless device can communicate with a pSIM card installed in the removable pSIM card accessory by sending and receiving application protocol data units (APDUs) via a wireless connection (or a wired connection in some instances) to allow the wireless device to use the pSIM card to access cellular wireless communication services of an MNO associated with the pSIM card. Exemplary wireless connections for wireless communication between the removable accessory, e.g., the removable pSIM card accessory, and the wireless device include one or more of: a near-field communication (NFC) connection, an ultra-wide band (UWB) connection, a wireless personal area network (WPAN) connection, such as a Bluetooth (BT) or Bluetooth Low Energy (BT LE) connection. In some cases, a single wireless connection is used for pairing and for communication of APDUs between the removable accessory and the wireless device. In some cases, a first wireless connection is used for pairing between the removable accessory and the wireless device, and a second wireless connection is used for communication of APDUs between the removable accessory and the wireless device. As functions of the removable accessory may require continuous power, e.g., a pSIM card requires continuous power supplied while in use, the removable accessory, such as a removable pSIM card accessory, can include power circuitry to allow for wireless power (or wired power in some instances) to be supplied to hardware of the removable accessory, e.g., to one or more pSIM cards and/or to other circuitry modules of the removable accessory. In some cases, the removable accessory includes a battery that can be charged and can supply power to a pSIM card and/or to the other circuitry modules of the removable accessory. In some cases, the removable accessory does not include a battery, and wireless or wired power can be supplied to the removable accessory in order for the removable accessory to be able to provide functions to the wireless device, such as to access wireless communication services authorized by a pSIM card included in a removable pSIM card accessory. The removable accessory can include wireless charging coils to allow for wireless power transfer to the removable accessory, such as from the wireless device and/or from an external charging pad. The removable accessory can be configured to allow for time-division shared wireless charging of the card accessory and of the wireless device to which the removable accessory is attached.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3 illustrates examples of removable accessories, in particular removable physical subscriber identity (pSIM) card accessories, according to some embodiments.

FIGS. 4A to 4E illustrate several exemplary options for wireless connection and communication between a removable accessory, e.g., a removable pSIM card accessory, and a wireless device, according to some embodiments.

FIGS. 4F and 4G illustrate exemplary options for wireless connection and communication between a removable accessory and a wireless device, according to some embodiments.

FIG. 5A illustrates exemplary wireless power supply options for an exemplary removable accessory, e.g., a removable pSIM card accessory, according to some embodiments.

FIG. 5B illustrates exemplary wireless power supply options for a removable accessory, according to some embodiments.

FIG. 5C illustrates an exemplary architecture for an exemplary combined wired and wireless removable accessory, e.g., a combined wired and wireless removable pSIM card accessory, according to some embodiments.

FIG. 5D illustrates an exemplary architecture for a combined wired and wireless removable accessory, according to some embodiments.

FIGS. 6A and 6B illustrate an exemplary process for sharing wireless charging of a wireless charging pad between a wireless device and a removable accessory coupled to the wireless device, according to some embodiments.

FIG. 6C illustrates a sequence diagram of various states of wireless charging coils for a removable accessory and for a wireless device when performing shared wireless charging, according to some embodiments.

FIG. 7A illustrates an exemplary method for management of wireless charging of an exemplary removable accessory, e.g., a removable pSIM card accessory, coupled to a wireless device, according to some embodiments.

FIG. 7B illustrates an exemplary method for management of wireless charging of a removable accessory coupled to a wireless device, according to some embodiments.

FIG. 8 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This Application describes removable accessories for a wireless device, e.g., physical subscriber identity module (pSIM) card accessories that can be coupled to a wireless device. A removable accessory, such as a case or an external wallet, for a wireless device can include hardware and a power charging capability to allow the wireless device to use functions of the accessory an to wirelessly charge the accessory. In a representative embodiment, the wireless devices does not include a slot or tray for holding pSIMs, and the wireless device can connect with and use a pSIM in the accessory to communicate with a cellular wireless network.

A wireless device can include an embedded universal integrated circuit card (eUICC), on which electronic SIMs (eSIMs) can be loaded and used for communicating with one or more cellular wireless networks. The wireless device, in some embodiments, can exclude a pSIM slot and/or tray in which to install a pSIM card. In order to use a pSIM card with the wireless device that does not include a pSIM card slot or tray, the wireless device can be supplemented with an external, removable accessory, such as a case or a stand-alone wallet that includes a pSIM slot and/or tray in which to install one or more pSIMs. The removable pSIM card accessory can couple to the wireless device, via a wireless and/or wired connection, and can allow the wireless device to use the pSIM card to access cellular wireless services of an MNO associated with the pSIM card.

The removable pSIM card accessory can support use one or more pSIMs with a wireless device, such as an eSIM-only capable wireless device. The removable pSIM card accessory can attach to the wireless device, e.g., as a physical snap-on case or as a magnetically attached case, in some embodiments. The removable pSIM card accessory can pair with and connect to the wireless device via a wireless connection (or via a wired connection in some instances). A baseband processor of the wireless device can communicate with a pSIM card installed in the removable pSIM card accessory by sending and receiving application protocol data units (APDUs) via a wireless connection (or a wired connection in some instances) to allow the wireless device to use the pSIM card to access cellular wireless communication services of an MNO associated with the pSIM card. Exemplary wireless connections for wireless communication between the removable pSIM accessory device and the wireless device include one or more of: a near-field communication (NFC) connection, an ultra-wide band (UWB) connection, a wireless personal area network (WPAN) connection, such as a Bluetooth (BT) or Bluetooth Low Energy (BTLE) connection. In some cases, a single wireless connection is used both for pairing of the removable pSIM card accessory with the wireless device and for communication of APDUs between the removable pSIM card accessory and the wireless device. In some cases, a first wireless connection is used for pairing between the removable pSIM card accessory and the wireless device, and a second wireless connection is used for communication of APDUs between the removable pSIM card accessory and the wireless device. For example, an NFC connection can be used for secure pairing of the wireless device with the removable pSIM card accessory, and a BT connection, a BTLE connection, or a UWB connection can be used for relaying APDUs between a baseband processor of the wireless device and the pSIM card in the removable pSIM card accessory.

As a pSIM card requires continuous power to be supplied to the pSIM card while in use, the removable pSIM card accessory can include power circuitry to allow for wireless power (or wired power in some instances) to be supplied to the pSIM card and to other circuitry modules of the removable pSIM card accessory. In some cases, the removable pSIM card accessory includes a battery that can be charged and can be used to supply power to the pSIM card and to other circuitry modules of the removable pSIM card accessory. In some cases, the removable pSIM card accessory does not include a battery, and wireless power (or wired power) needs to be supplied to the removable pSIM card accessory in order for the wireless device to access wireless communication services authorized by the pSIM card included in the removable pSIM card accessory. The removable pSIM card accessory can include wireless charging coils to allow for wireless power transfer to the removable pSIM card accessory, such as from the wireless device and/or from an external charging pad. The removable pSIM card accessory can be configured to share wireless charging of the removable pSIM card accessory with the wireless device. To avoid wireless charging interference between the removable pSIM card accessory and the wireless device, wireless charging coils of either the removable pSIM card accessory or of the wireless device can be used for wireless charging at any given time, e.g., to allow for wireless power transfer from a wireless charging pad. In some cases, the removable pSIM card accessory indicates to the wireless device a requirement for wireless charging, and the wireless device disables its own wireless charging coils (if in use) and subsequently indicates to the removable pSIM card accessory that wireless charging for the removable pSIM card accessory is permitted. The removable pSIM card accessory can charge wirelessly via its own wireless charging coils until sufficient power is stored (when a battery is included in the removable pSIM card accessory) and then indicate to the wireless device that wireless charging by the removable pSIM card accessory has completed. In some cases, the removable pSIM card accessory does not include a battery, and wireless power (or wired power in some instances) is supplied to the pSIM card of the removable pSIM card accessory from either the wireless device, from an external charging pad, or via a wired power connection.

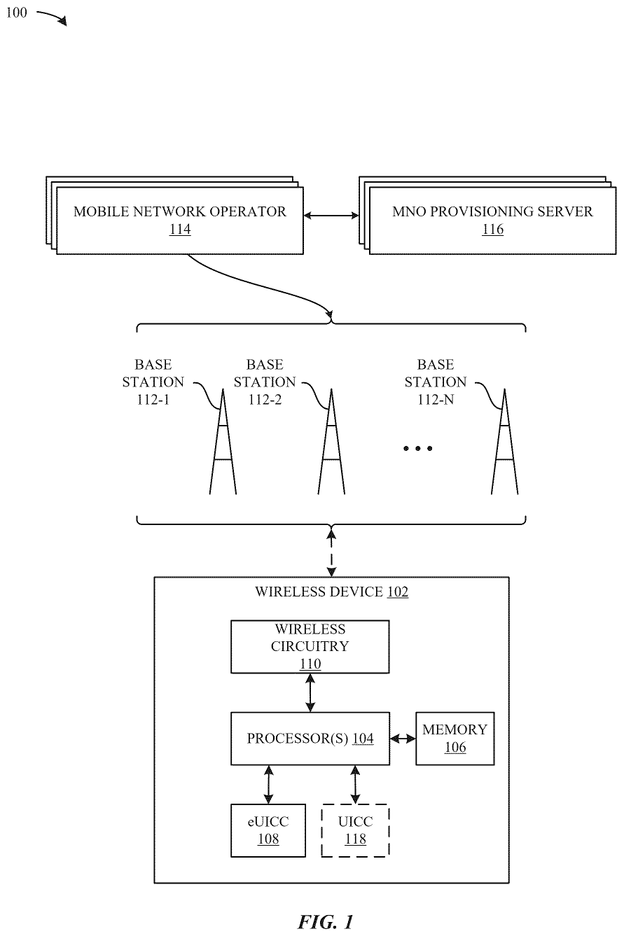

These and other embodiments are discussed below with reference to FIGS. 1-8; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a mobile wireless device, a cellular wireless device, a mobile device, a user equipment (UE) and the like, a group of base stations 112-1 to 112-N that are managed by different Mobile Network Operators (MNOs) 114, and a set of provisioning servers 116 that are in communication with the MNOs 114. Additional MNO infrastructure servers, such as used for account management and billing are not shown. The wireless device 102 can represent a mobile computing device (e.g., an iPhone® or an iPad® by Apple®), the base stations 112-1 to 112-n can represent cellular wireless network entities including evolved NodeBs (eNodeBs or eNBs) and/or next generation NodeBs (gNodeBs or gNB) that are configured to communicate with the wireless device 102, and the MNOs 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, an embedded Universal Integrated Circuit Card (eUICC) 108, and baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, a wireless device 102 can include one or more physical UICCs 118, also referred to as physical Subscriber Identity Module (pSIM) cards, or simply SIM cards, in addition to or substituting for the eUICC 108; however, in the wireless devices 102 discussed further herein, the wireless device 102 includes an eUICC 108 but does not directly support use of pSIM cards 118. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through base stations 112-1 to 112-N. For example, the eUICC 108 can be configured to store and manage one or more eSIMs for one or more MNOs 114 for different subscriptions to which the wireless device 102 is associated. To be able to access services provided by an MNO, an eSIM is reserved for subsequent download and installation to the eUICC 108. In some embodiments, the eUICC 108 obtains one or more eSIMs from one or more associated provisioning servers 116 as part of a device initialization of the wireless device 102, such as when purchasing a new wireless device 102. The provisioning servers 116 can be maintained by a manufacturer of the wireless device 102, the MNOs 114, third party entities, and the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel.

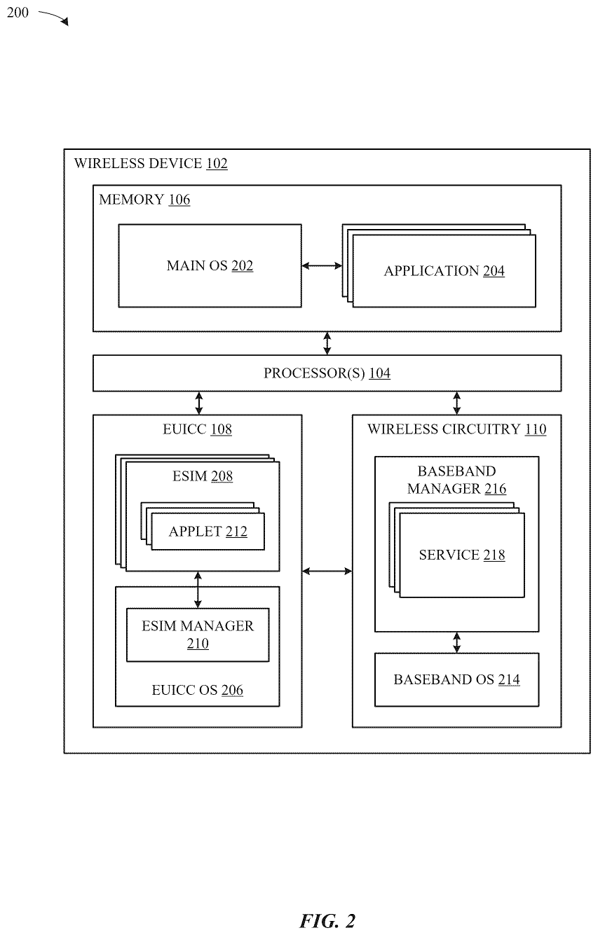

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM data) from the MNO provisioning server 116 for purposes of managing eSIMs 208. The baseband manager 216 can be configured to implement services 218, which represents a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

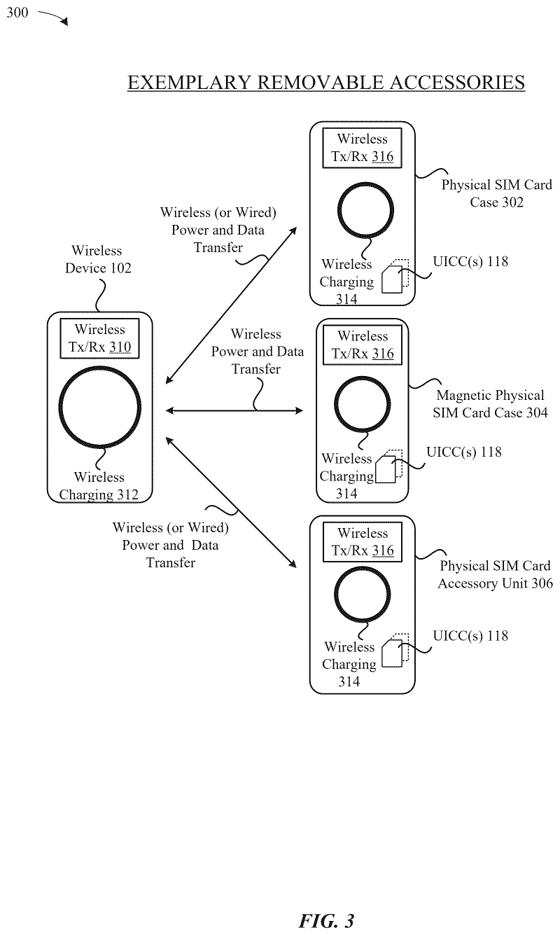

FIG. 3 illustrates a diagram 300 of several examples of different removable pSIM card accessories that can support use of one or more pSIM cards 118 for a wireless device 102. There are two main challenges to realize a pSIM card wireless accessory for supplementing a wireless device 102 that does not directly support a pSIM card 118: i) all application protocol data units (APDUs) for communication between the pSIM card 118 and an external processor, such as a baseband processor, need to be relayed via a wireless communication protocol, such as via BT, BTLE, NVC, and/or UWB, and ii) power must be continuously supplied to the pSIM card 118 while in use. Without power, the pSIM card may need to restart, which can result in a delay of multiple seconds or longer for the pSIM card to reset, connect to the wireless device, and for a baseband modem of the wireless device to scan and connect to a cellular wireless network. The wireless device 102 includes wireless transmit (TX) and wireless receive (RX) circuitry 310 with which the wireless device 102 can transfer wireless data with a removable pSIM card accessory. In addition, the wireless device 102 includes wireless charging coil(s) 312 that can be used to receive wireless power to the wireless device 102, and in some cases, can be used to transmit power to another device, such as to a removable pSIM card accessory. As shown in FIG. 3, a first removable pSIM accessory includes a physical SIM card case 302 that can attach to the wireless device 102, e.g., via mechanical attachment. The physical SIM card case 302 can include a slot and/or tray that allows for insertion of one or more pSIM cards 118 (also referred to as UICCs 118). The pSIM card case 302 also includes wireless TX/RX circuitry 316 that can be used to transmit and receive wireless data with another wireless device 102, such as with the wireless device 102. The pSIM card case 302 further includes wireless charging coil(s) 314 in order to receive wireless power from the wireless device 102 and/or from an external wireless charging pad. In some cases, the pSIM card case 302 includes a battery for power storage (not shown). A second removable pSIM accessory includes a magnetic physical SIM card case 304 that includes wireless TX/RX circuitry 316, wireless charging coil(s) 314, and a slot and/or tray that allows for insertion of one or more pSIM cards 118, where the magnetic pSIM card case 304 attaches to the wireless device via a magnetic connection. As with the pSIM card case 302, the magnetic pSIM card case 304 can wirelessly communicate with the wireless device 102 and can receive wireless power from the wireless device 102. A third removable pSIM accessory includes a physical SIM card accessory unit 306 that connects to the wireless device 102 wirelessly via wireless TX/RX circuitry 316 (e.g., via BT, BTLE, or UWB) and operates within a practical physical range of the wireless device 102, e.g., within a pocket or backpack near to the wireless device 102. In some cases, the pSIM card accessory unit 306 can be charged wirelessly via wireless charging coil(s) 314. In some cases, the pSIM card accessory unit 306 includes a battery that can be charged wirelessly or via a wired connection, such as a USB connection. As with the pSIM card case 302 and the magnetic pSIM card case 304, the pSIM card accessory unit 306 can wirelessly communicate with the wireless device 102 and, in some cases, can receive wireless power from the wireless device 102 when adjacent to the wireless device 102.

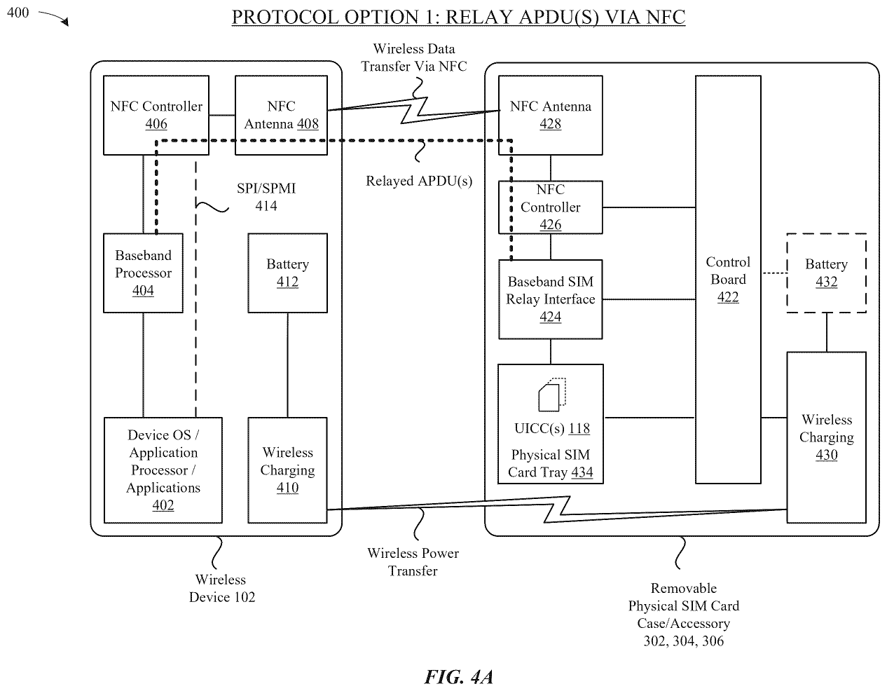

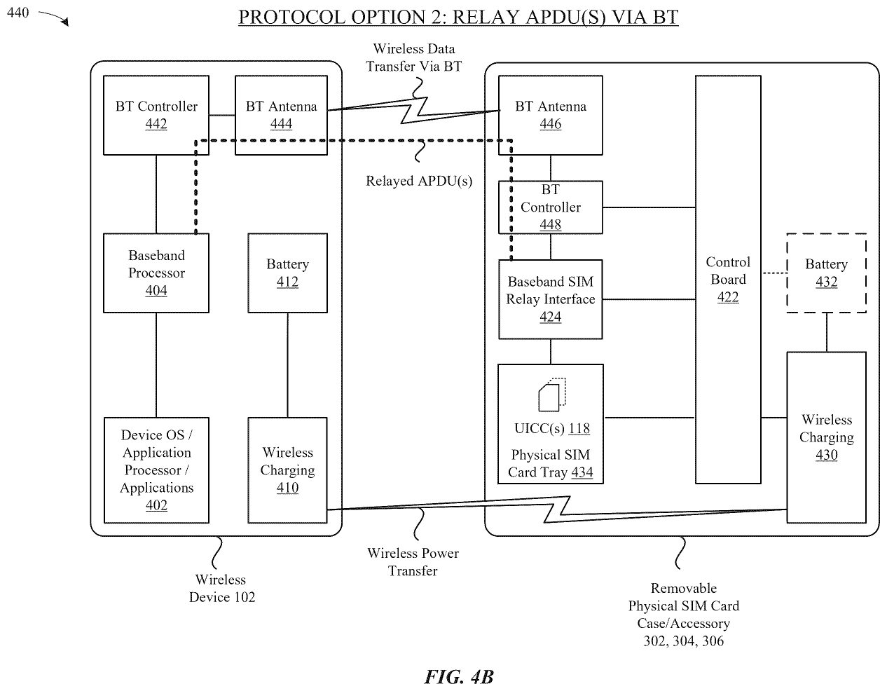

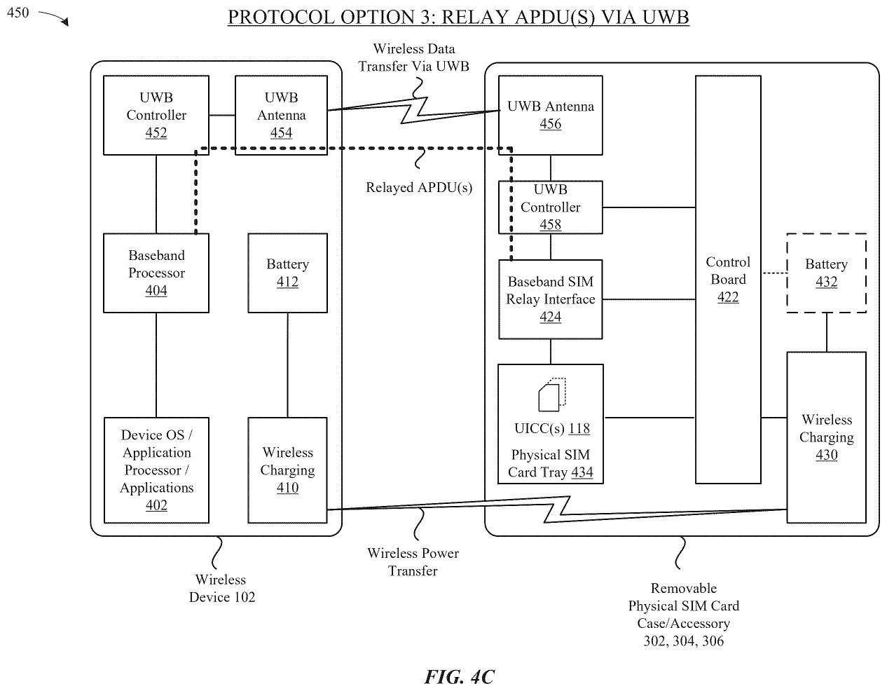

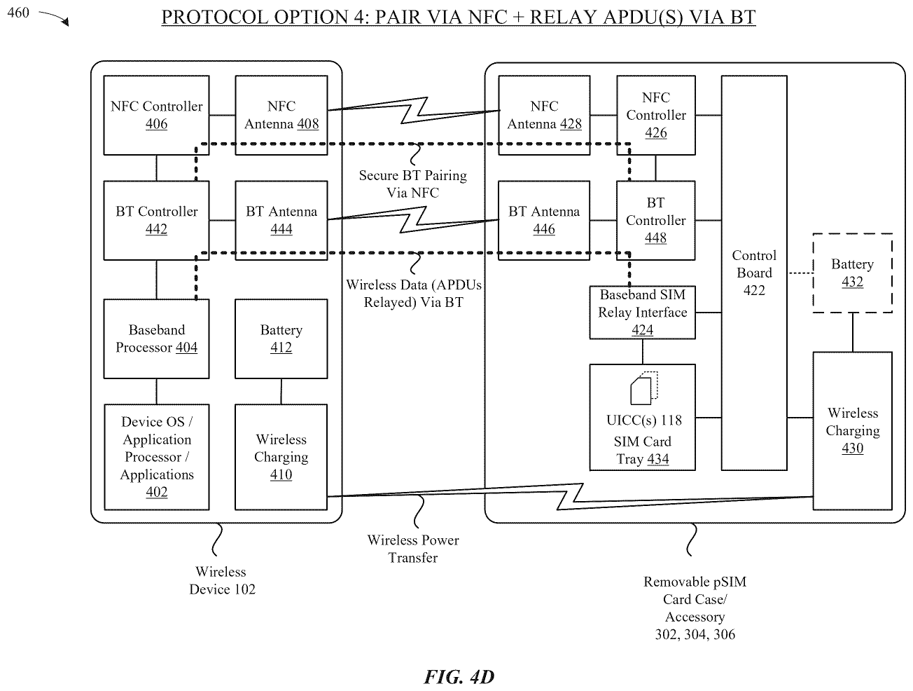

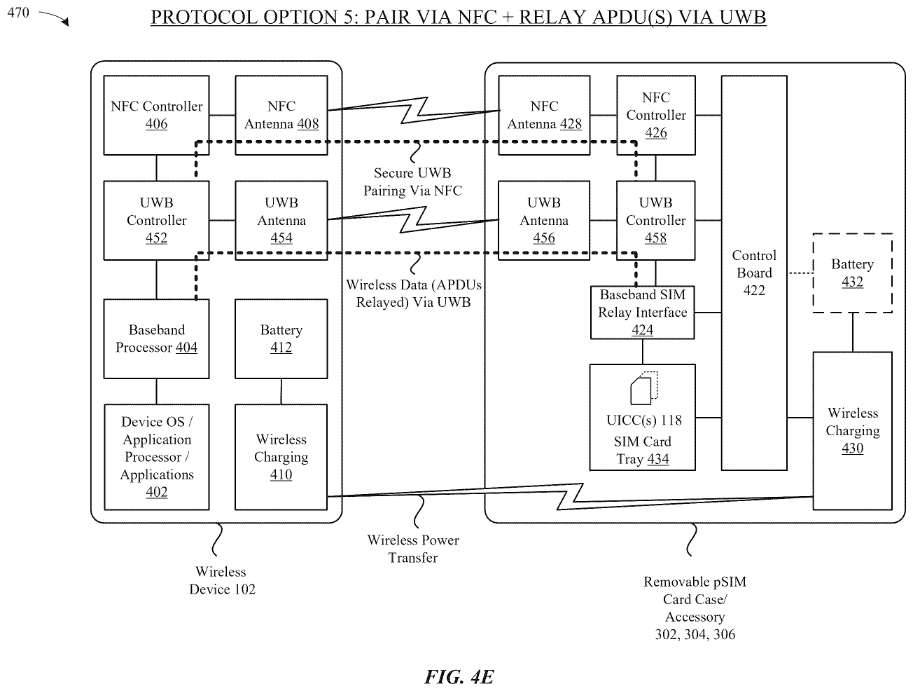

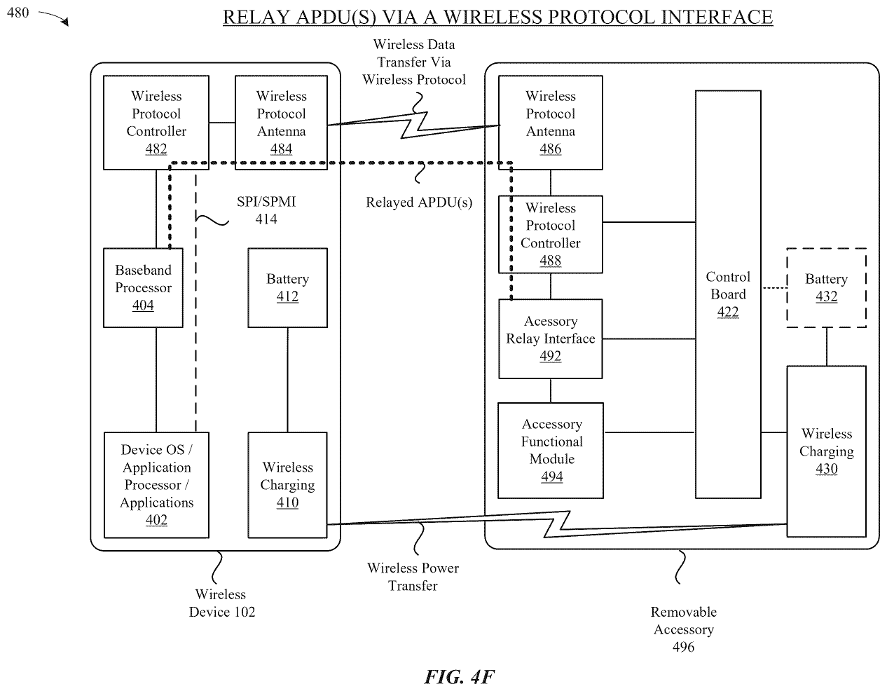

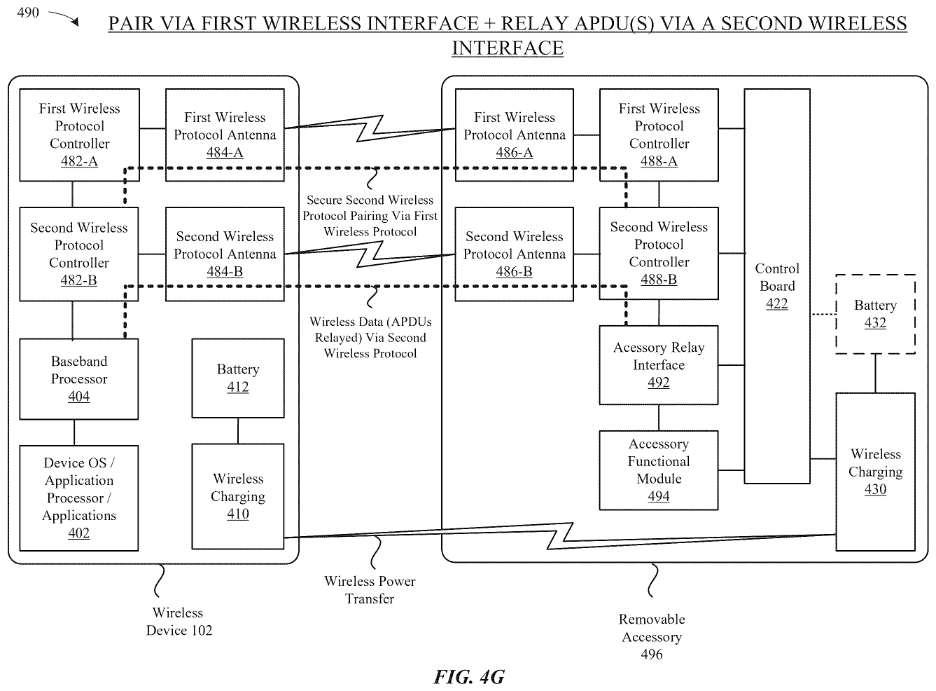

FIG. 4A illustrates a diagram 400 of a first option for wireless connection and communication between a wireless device 102 and a removable pSIM card case 302, 304 or accessory unit 306. The wireless device 102 includes an applications processor 402, which can support a device operating system (OS) and one or more device applications, where the applications processor 402 is connected to a baseband processor 404 (part of baseband wireless circuitry 110), and in some cases directly to a near-field communication (NFC) controller 406 via an SPI/SPMI interface 414. The NFC controller 406 manages NFC communication for the wireless device 102 and connects to an NFC antenna 408 (part of wireless TX/RX circuitry 310), which can transmit and receive NFC wireless signals that carry wireless data to and from the removable pSIM card case/accessory 302, 304, 306. APDUs from the baseband processor 404 can be encapsulated by the NFC controller 406 and communicated via the NFC antenna 408 to the removable pSIM card case/accessory 302, 304, 306. Similarly, APDUs can be received from the removable pSIM card case/accessory 302, 304, 306 via the NFC antenna 408 and de-encapsulated by the NFC controller 406 for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable pSIM card case/accessory 302, 304, 306.

The removable pSIM card case/accessory 302, 304, 306 includes a control board 422, which can include a processor, memory, and/or other circuitry required to manage and control additional modules of the removable pSIM card case/accessory 302, 304, 306. The control board 422 is connected to an NFC controller 426, which manages NFC communication via an NFC antenna 428 for the removable pSIM card case/accessory 302, 304, 306. APDUs from a pSIM card 118 (UICC 118) included in a pSIM card tray 434 of the removable pSIM card case/accessory 302, 304, 306 can be managed by a baseband SIM relay interface 424 and can be encapsulated by the NFC controller 426 of the removable pSIM card case/accessory 302, 304, 306. The encapsulated APDUs can be communicated by the NFC controller 426 via an NFC antenna 428 to baseband processor 404 of the wireless device 102. Similarly, APUS can be received from the wireless device 102 via the NFC antenna 428 and de-encapsulated by the NFC controller 426 for transfer via the baseband SIM relay interface 424 to the pSIM card 118 (UICC 118) included in the pSIM card tray 434 of the removable pSIM card case/accessory 302, 304, 306. In some embodiments, the removable pSIM card case/accessory 302, 304, 306 includes a battery 432 for local storage of power, while in other embodiments, the removable pSIM card case/accessory 302, 304, 306 does not include a battery 432. The removable pSIM card case/accessory 302, 304, 306 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable pSIM card case/accessory 302, 304, 306, including the pSIM card 118 included in the pSIM card tray 434, as well as the control board 422, the baseband SIM relay interface 424, the NFC controller 426, and the NFC antenna 428. When the removable pSIM card case/accessory includes a battery 432, the wireless charging circuitry 430 can receive and transfer power to the battery 432 for storage and subsequent use when wireless power transfer is not available.

The wireless device 102 and the removable pSIM card case/accessory 302, 304, 306 can use the NFC interface both for secure pairing together and for wireless data transfer of encapsulated APDUs. Secure pairing of the wireless device 102 with the removable pSIM card case/accessory 302, 304, 306 can be initiated during an initial power up procedure. In some embodiments, pairing via NFC can use a secure pairing and key exchange (SPAKE) protocol, e.g., SPAKE2+. In some embodiments, pairing via NFC can use a temporary pairing (TNEP) protocol, e.g., where SIM information in the pSIM card 118 (UICC 118) is used to derive pairing data. Pairing of the wireless device 102 with the removable pSIM card case/accessory 302, 304, 306 can persist until the pSIM card 118 (UICC 118) is removed from the removable pSIM card case/accessory 302, 304, 306.

FIG. 4B illustrates a diagram 440 of a second option for wireless connection and communication between a wireless device 102 and a removable pSIM card case 302, 304 or accessory unit 306. The wireless device 102 includes an applications processor 402, which can support a device operating system (OS) and one or more device applications, where the applications processor 402 is connected to a baseband processor 404 (part of baseband wireless circuitry 110). A Bluetooth (BT) controller 442 manages BT communication for the wireless device 102 and connects to a BT antenna 444 (part of wireless TX/RX circuitry 310), which can transmit and receive BT wireless signals that carry wireless data to the removable pSIM card case/accessory 302, 304, 306. APDUs from the baseband processor 404 can be encapsulated by the BT controller 442 and communicated via the BT antenna 444 to the removable pSIM card case/accessory 302, 304, 306. Similarly, APDUs can be received from the removable pSIM card case/accessory 302, 304, 306 via the BT antenna 444 and de-encapsulated by the BT controller 442 for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable pSIM card case/accessory 302, 304, 306.

The removable pSIM card case/accessory 302, 304, 306 includes a control board 422, which can include a processor, memory, and/or other circuitry required to manage and control additional modules of the removable pSIM card case/accessory 302, 304, 306. The control board 422 is connected to a BT controller 448, which manages BT communication via a BT antenna 446 for the removable pSIM card case/accessory 302, 304, 306. APDUs from a pSIM card 118 (UICC 118) included in a pSIM card tray 434 of the removable pSIM card case/accessory 302, 304, 306 can be managed by a baseband SIM relay interface 424 and can be encapsulated by the BT controller 448 of the removable pSIM card case/accessory 302, 304, 306. The encapsulated APDUs can be communicated by the BT controller 448 via a BT antenna 446 to baseband processor 404 of the wireless device 102. Similarly, APDUs can be received from the wireless device 102 via the BT antenna 446 and de-encapsulated by the BT controller 448 for transfer via the baseband SIM relay interface 424 to the pSIM card 118 (UICC 118) included in the pSIM card tray 434 of the removable pSIM card case/accessory 302, 304, 306. In some embodiments, the removable pSIM card case/accessory 302, 304, 306 includes a battery 432 for local storage of power, while in other embodiments, the removable pSIM card case/accessory 302, 304, 306 does not include a battery 432. The removable pSIM card case/accessory 302, 304, 306 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable pSIM card case/accessory 302, 304, 306, including the pSIM card 118 included in the pSIM card tray 434, as well as the control board 422, the baseband SIM relay interface 424, the BT controller 448, and the BT antenna 446. When the removable pSIM card case/accessory 302, 304, 306 includes a battery 432, the wireless charging circuitry 430 can receive and transfer power to the battery 432 for storage and subsequent use when wireless power transfer is not available.

The wireless device 102 and the removable pSIM card case/accessory 302, 304, 306 can use the BT interface both for secure pairing together and for wireless data transfer of encapsulated APDUs. Secure pairing of the wireless device 102 with the removable pSIM card case/accessory 302, 304, 306 can be initiated during an initial power up procedure. In some embodiments, pairing via BT can use a temporary pairing (TNEP) protocol, e.g., where SIM information in the pSIM card 118 (UICC 118) is used to derive pairing data. Pairing of the wireless device 102 with the removable pSIM card case/accessory 302, 304, 306 can persist until the pSIM card 118 (UICC 118) is removed from the removable pSIM card case/accessory 302, 304, 306.

FIG. 4C illustrates a diagram 450 of a third option for wireless connection and communication between a wireless device 102 and a removable pSIM card case 302, 304 or accessory unit 306. The wireless device 102 includes an applications processor 402, which can support a device operating system (OS) and one or more device applications, where the applications processor 402 is connected to a baseband processor 404 (part of baseband wireless circuitry 110). An ultra-wideband (UWB) controller 452 manages UWB communication for the wireless device 102 and connects to an UWB antenna 454 (part of wireless TX/RX circuitry 310), which can transmit and receive UWB wireless signals that carry wireless data to the removable pSIM card case/accessory 302, 304, 306. APDUs from the baseband processor 404 can be encapsulated by the UWB controller 452 and communicated via the UWB antenna 454 to the removable pSIM card case/accessory 302, 304, 306. Similarly, APDUs can be received from the removable pSIM card case/accessory 302, 304, 306 via the UWB antenna 456 and de-encapsulated by the UWB controller 452 for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable pSIM card case/accessory 302, 304, 306.

The removable pSIM card case/accessory 302, 304, 306 includes a control board 422, which can include a processor, memory, and/or other circuitry required to manage and control additional modules of the removable pSIM card case/accessory 302, 304, 306. The control board 422 is connected to an UWB controller 458, which manages UWB communication via an UWB antenna 456 for the removable pSIM card case/accessory 302, 304, 306. APDUs from a pSIM card 118 (UICC 118) included in a pSIM card tray 434 of the removable pSIM card case/accessory 302, 304, 306 can be managed by a baseband SIM relay interface 424 and can be encapsulated by the UWB controller 458 of the removable pSIM card case/accessory 302, 304, 306. The encapsulated APDUs can be communicated by the UWB controller 458 via an UWB antenna 456 to baseband processor 404 of the wireless device 102. Similarly, APDUs can be received from the wireless device 102 via the UWB antenna 456 and de-encapsulated by the UWB controller 458 for transfer via the baseband SIM relay interface 424 to the pSIM card 118 (UICC 118) included in the pSIM card tray 434 of the removable pSIM card case/accessory 302, 304, 306. In some embodiments, the removable pSIM card case/accessory 302, 304, 306 includes a battery 432 for local storage of power, while in other embodiments, the removable pSIM card case/accessory 302, 304, 306 docs not include a battery 432. The removable pSIM card case/accessory 302, 304, 306 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable pSIM card case/accessory 302, 304, 306, including the pSIM card 118 included in the pSIM card tray 434, as well as the control board 422, the baseband SIM relay interface 424, the UWB controller 458, and the UWB antenna 456. When the removable pSIM card case/accessory 302, 304, 306 includes a battery 432, the wireless charging circuitry 430 can receive and transfer power to the battery 432 for storage and subsequent use when wireless power transfer is not available.

The wireless device 102 and the removable pSIM card case/accessory 302, 304, 306 can use the UWB interface both for secure pairing together and for wireless data transfer of encapsulated APDUs. Secure pairing of the wireless device 102 with the removable pSIM card case/accessory 302, 304, 306 can be initiated during an initial power up procedure. In some embodiments, pairing via UWB can use a temporary pairing (TNEP) protocol, e.g., where SIM information in the pSIM card 118 (UICC 118) is used to derive pairing data. Pairing of the wireless device 102 with the removable pSIM card case/accessory 302, 304, 306 can persist until the pSIM card 118 (UICC 118) is removed from the removable pSIM card case/accessory 302, 304, 306.

FIG. 4D illustrates a diagram 460 of a fourth option for wireless connection and communication between a wireless device 102 and a removable pSIM card case 302, 304 or accessory unit 306. The wireless device 102 includes an applications processor 402, which can support a device operating system (OS) and one or more device applications, where the applications processor 402 is connected to a baseband processor 404 (part of baseband wireless circuitry 110). An NFC controller 406 manages NFC communication for the wireless device 102 and connects to an NFC antenna 408 (part of wireless TX/RX circuitry 310), which can transmit and receive NFC wireless signals to and from the removable pSIM card case/accessory 302, 304, 306. The NFC controller 406 and the NFC antenna 408 can be used to communicate BT packets for secure BT pairing between the wireless device 102 and the removable pSIM card case/accessory 302, 304, 306. A separate Bluetooth (BT) controller 442 manages BT communication for the wireless device 102 and connects to a BT antenna 444 (also part of wireless TX/RX circuitry 310), which can transmit and receive BT wireless signals that carry wireless data to and from the removable pSIM card case/accessory 302, 304, 306. APDUs from the baseband processor 404 can be encapsulated by the BT controller 442 and communicated via the BT antenna 444 to the removable pSIM card case/accessory 302, 304, 306. Similarly, APDUs can be received from the removable pSIM card case/accessory 302, 304, 306 via the BT antenna 444 and de-encapsulated by the BT controller 442 for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable pSIM card case/accessory 302, 304, 306.

The removable pSIM card case/accessory 302, 304, 306 includes a control board 422, which can include a processor, memory, and/or other circuitry required to manage and control additional modules of the removable pSIM card case/accessory 302, 304, 306. The control board 422 is connected to an NFC controller 426, which manages NFC communication via an NFC antenna 428 for the removable pSIM card case/accessory 302, 304, 306. Secure BT pairing of the removable pSIM card case/accessory 302, 304, 306 can be performed by secure NFC communication with the wireless device 102, where the NFC wireless circuitry relays BT packets for BT pairing. After secure pairing is accomplished, BT data packets (that encapsulate APDUs for the pSIM card) can be communicated directly via BT wireless circuitry. The control board 422 is also connected to a BT controller 448, which manages BT communication via a BT antenna 446 for the removable pSIM card case/accessory 302, 304, 306. APDUs from a pSIM card 118 (UICC 118) included in a pSIM card tray 434 of the removable pSIM card case/accessory 302, 304, 306 can be managed by a baseband SIM relay interface 424 and can be encapsulated by the BT controller 448 of the removable pSIM card case/accessory 302, 304, 306. The encapsulated APDUs can be communicated by the BT controller 448 via the BT antenna 446 to the baseband processor 404 of the wireless device 102. Similarly, APDUs can be received from the wireless device 102 via the BT antenna 446 and de-encapsulated by the BT controller 448 for transfer via the baseband SIM relay interface 424 to the pSIM card 118 (UICC 118) included in the pSIM card tray 434 of the removable pSIM card case/accessory 302, 304, 306. In some embodiments, the removable pSIM card case/accessory 302, 304, 306 includes a battery 432 for local storage of power, while in other embodiments, the removable pSIM card case/accessory 302, 304, 306 does not include a battery 432. The removable pSIM card case/accessory 302, 304, 306 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable pSIM card case/accessory 302, 304, 306, including the pSIM card 118 included in the pSIM card tray 434, as well as the control board 422, the baseband SIM relay interface 424, the BT controller 448, the BT antenna 446, the NFC controller 426, and the NFC antenna 428. When the removable pSIM card case/accessory 302, 304, 306 includes a battery 432, the wireless charging circuitry 430 can receive and transfer power to the battery 432 for storage and subsequent use when wireless power transfer is not available.

The wireless device 102 and the removable pSIM card case/accessory 302, 304, 306 can use the NFC interface for secure pairing and the BT interface for wireless data transfer of encapsulated APDUs. Secure pairing of the wireless device 102 with the removable pSIM card case/accessory 302, 304, 306 can be initiated during an initial power up procedure. In some embodiments, pairing via NFC can use a secure pairing and key exchange (SPAKE) protocol, e.g., SPAKE2+. In some embodiments, pairing via NFC can use a temporary pairing (TNEP) protocol, e.g., where SIM information in the pSIM card 118 (UICC 118) is used to derive pairing data. Pairing of the wireless device 102 with the removable pSIM card case/accessory 302, 304, 306 can persist until the pSIM card 118 (UICC 118) is removed from the removable pSIM card case/accessory 302, 304, 306.

FIG. 4E illustrates a diagram 470 of a fifth option for wireless connection and communication between a wireless device 102 and a removable pSIM card case 302, 304 or accessory unit 306. The wireless device 102 includes an applications processor 402, which can support a device operating system (OS) and one or more device applications, where the applications processor 402 is connected to a baseband processor 404 (part of baseband wireless circuitry 110). An NFC controller 406 manages NFC communication for the wireless device 102 and connects to an NFC antenna 408 (part of wireless TX/RX circuitry 310), which can transmit and receive NFC wireless signals to and from the removable pSIM card case/accessory 302, 304, 306. The NFC controller 406 and the NFC antenna 408 can be used to communicate UWB packets for secure UWB pairing between the wireless device 102 and the removable pSIM card case/accessory 302, 304, 306. A separate UWB controller 452 manages UWB communication for the wireless device 102 and connects to an UWB antenna 454 (also part of wireless TX/RX circuitry 310), which can transmit and receive UWB wireless signals that carry wireless data to and from the removable pSIM card case/accessory 302, 304, 306. APDUs from the baseband processor 404 can be encapsulated by the UWB controller 452 and communicated via the BT antenna 444 to the removable pSIM card case/accessory 302, 304, 306. Similarly, APDUs can be received from the removable pSIM card case/accessory 302, 304, 306 via the UWB antenna 454 and de-encapsulated by the UWB controller 452 for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable pSIM card case/accessory 302, 304, 306.

The removable pSIM card case/accessory 302, 304, 306 includes a control board 422, which can include a processor, memory, and/or other circuitry required to manage and control additional modules of the removable pSIM card case/accessory 302, 304, 306. The control board 422 is connected to an NFC controller 426, which manages NFC communication via an NFC antenna 428 for the removable pSIM card case/accessory 302, 304, 306. Secure UWB pairing of the removable pSIM card case/accessory 302, 304, 306 can be performed by secure NFC communication with the wireless device 102, where the NFC wireless circuitry relays UWB packets for UWB pairing. After secure pairing is accomplished, UWB data packets (that encapsulate APDUs for the pSIM card) can be communicated directly via UWB wireless circuitry. The control board 422 is also connected to a UWB controller 458, which manages UWB communication via a UWB antenna 456 for the removable pSIM card case/accessory 302, 304, 306. APDUs from a pSIM card 118 (UICC 118) included in a pSIM card tray 434 of the removable pSIM card case/accessory 302, 304, 306 can be managed by a baseband SIM relay interface 424 and can be encapsulated by the UWB controller 458 of the removable pSIM card case/accessory 302, 304, 306. The encapsulated APDUs can be communicated by the UWB controller 458 via the UWB antenna 456 to the baseband processor 404 of the wireless device 102. Similarly, APDUs can be received from the wireless device 102 via the UWB antenna 456 and de-encapsulated by the UWB controller 458 for transfer via the baseband SIM relay interface 424 to the pSIM card 118 (UICC 118) included in the pSIM card tray 434 of the removable pSIM card case/accessory 302, 304, 306. In some embodiments, the removable pSIM card case/accessory 302, 304, 306 includes a battery 432 for local storage of power, while in other embodiments, the removable pSIM card case/accessory 302, 304, 306 does not include a battery 432. The removable pSIM card case/accessory 302, 304, 306 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable pSIM card case/accessory 302, 304, 306, including the pSIM card 118 included in the pSIM card tray 434, as well as the control board 422, the baseband SIM relay interface 424, the UWB controller 458, the UWB antenna 456, the NFC controller 426, and the NFC antenna 428. When the removable pSIM card case/accessory 302, 304, 306 includes a battery 432, the wireless charging circuitry 430 can receive and transfer power to the battery 432 for storage and subsequent use when wireless power transfer is not available.

The wireless device 102 and the removable pSIM card case/accessory 302, 304, 306 can use the NFC interface for secure pairing and the UWB interface for wireless data transfer of encapsulated APDUs. Secure pairing of the wireless device 102 with the removable pSIM card case/accessory 302, 304, 306 can be initiated during an initial power up procedure. In some embodiments, pairing via NFC can use a secure pairing and key exchange (SPAKE) protocol, e.g., SPAKE2+. In some embodiments, pairing via NFC can use a temporary pairing (TNEP) protocol, e.g., where SIM information in the pSIM card 118 (UICC 118) is used to derive pairing data. Pairing of the wireless device 102 with the removable pSIM card case/accessory 302, 304, 306 can persist until the pSIM card 118 (UICC 118) is removed from the removable pSIM card case/accessory 302, 304, 306.

FIG. 4F illustrates a diagram 480 of using a wireless communication protocol to connect and communicate between a wireless device 102 and a removable accessory 496. As in the diagrams 400, 440, 450 of FIGS. 4A, 4B, and 4C, the wireless device 102 includes an applications processor 402, which can support a device operating system (OS) and one or more device applications, where the applications processor 402 is connected to a baseband processor 404 (part of baseband wireless circuitry 110), and in some cases (e.g., depending on the particular wireless communication protocol used) directly to a wireless protocol controller 482 via an SPI/SPMI interface 414. The wireless protocol controller 482 manages communication according to a particular wireless communication protocol for the wireless device 102, e.g., NFC, BT, UWB, and connects to a wireless protocol antenna 484 (part of wireless TX/RX circuitry 310), which can transmit and receive wireless signals that carry wireless data to and from the removable accessory 496. Data, e.g., APDUs, from the baseband processor 404 can be encapsulated by the wireless protocol controller 482 and communicated via the wireless protocol antenna 4648 to the removable accessory 496. Similarly, data, e.g., APDUs, can be received from the removable accessory 496 via the wireless protocol antenna 484 and de-encapsulated by the wireless protocol controller 482 for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable accessory 496.

The removable accessory 496 includes a control board 422, which can include a processor, memory, and/or other circuitry required to manage and control additional modules of the removable accessory 496. The control board 422 is connected to a wireless protocol controller 488, which manages wireless protocol communication via an NFC antenna 428 for the removable accessory 496. Data, e.g., APDUs, from an accessory functional module 494 can be managed by an accessory relay interface 492 and can be encapsulated by the wireless protocol controller 488 of the removable accessory 496. The encapsulated APDUs can be communicated by the wireless protocol controller 488 via a wireless protocol antenna 486 to the one or more processors of the wireless device 102, e.g., to the baseband processor 404 and/or forwarded to the applications processor 402 of the wireless device 102. Similarly, data, e.g., APDUs, can be received by the removable accessory 496 from the wireless device 102 via the wireless protocol antenna 486 and de-encapsulated by the wireless protocol controller 488 for transfer via the accessory relay interface 492 to the accessory functional module 494 and/or to the control board 422. In some embodiments, the removable accessory 496 includes a battery 432 for local storage of power, while in other embodiments, the removable accessory 496 does not include a battery 432. The removable accessory 496 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable accessory 496, including the accessory functional module 494, as well as the control board 422, the accessory relay interface 492, the wireless protocol controller 488, and the wireless protocol antenna 486. When the removable accessory 496 includes a battery 432, the wireless charging circuitry 430 can receive and transfer power to the battery 432 for storage and subsequent use when wireless power transfer is not available.

The wireless device 102 and the removable accessory 496 can use the wireless protocol interface both for secure pairing together and for wireless data transfer of encapsulated data, e.g., encapsulated APDUs. Secure pairing of the wireless device 102 with the removable accessory 496 can be initiated during an initial power up procedure. In some embodiments, e.g., where the wireless communication protocol includes NFC, pairing via NFC can use a secure pairing and key exchange (SPAKE) protocol, e.g., SPAKE2+. In some embodiments, pairing via the wireless communication protocol can use a temporary pairing (TNEP) protocol. In some embodiments information from the accessory functional module can be used to derive pairing data. Pairing of the wireless device 102 with the removable accessory 496 can persist until a configuration of the accessory functional module 494 changes.

FIG. 4G illustrates a diagram 490 of using two different wireless communication protocols to connect and communicate between a wireless device 102 and a removable accessory 496. The wireless device 102 includes an applications processor 402, which can support a device operating system (OS) and one or more device applications, where the applications processor 402 is connected to a baseband processor 404 (part of baseband wireless circuitry 110). A first wireless protocol controller 492-A manages communication via a first wireless communication protocol for the wireless device 102 and connects to a first wireless protocol antenna 484-A (part of wireless TX/RX circuitry 310), which can transmit and receive first wireless protocol signals to and from the removable accessory 496. The first wireless protocol controller 482-A and the first wireless protocol antenna 484-A can be used to communicate first wireless communication protocol packets for secure pairing between the wireless device 102 and the removable accessory 496. A second wireless protocol controller 482-B manages second wireless protocol communication for the wireless device 102 and connects to a second wireless protocol antenna 484-B (also part of wireless TX/RX circuitry 310), which can transmit and receive second wireless communication protocol signals that carry wireless data to and from the removable accessory 496. Data, e.g., APDUs, from the baseband processor 404 can be encapsulated by the second wireless protocol controller 482-B and communicated via the second wireless protocol antenna 484-B to the removable accessory 496. Similarly, data, e.g., APDUs, can be received from the removable accessory 496 via the second wireless protocol antenna 484-B and de-encapsulated by the second wireless protocol controller 482-B for transfer to the baseband processor 404 of the wireless device 102. The wireless device 102 further includes a battery 412 for local power storage, and wireless charging circuitry 410 (which includes wireless charging coils 314) that can be used to receive wireless power, e.g., from a wireless charging pad, and can also be used to transmit wireless power to the removable accessory 496.

The removable accessory 496 includes a control board 422, which can include a processor, memory, and/or other circuitry required to manage and control additional modules of the removable accessory 496. The control board 422 is connected to a first wireless protocol controller 488-A, which manages communication in accordance with a first wireless communication protocol via a first wireless protocol antenna 486-A for the removable accessory 496. Secure pairing of the removable accessory 496 can be performed by communication via a second wireless communication protocol with the wireless device 102, where the first wireless protocol circuitry relays packets (via circuitry using the first wireless communication protocol) for the secure second wireless protocol pairing. After secure pairing is accomplished, data packets (e.g., that encapsulate data, e.g., APDUs, for the accessory functional module 494) can be communicated directly via second wireless protocol circuitry. The control board 422 is also connected to a second wireless protocol controller 448-B, which manages communication in accordance with a second wireless communication protocol via a second wireless protocol antenna 486-B for the removable accessory 496. Data, e.g., APDUs, from an accessory functional module 494 of the removable accessory 496 can be managed by an accessory relay interface 492 and can be encapsulated by the second wireless protocol controller 488-B of the removable accessory 496. The encapsulated data, e.g., encapsulated APDUs, can be communicated by the second wireless protocol controller 488-B via the second wireless protocol antenna 486-B to the baseband processor 404 and/or forwarded to the applications processor 402 of the wireless device 102. Similarly, data, e.g., APDUs, can be received from the wireless device 102 via the second wireless protocol antenna 486-B and de-encapsulated by the second wireless protocol controller 488-B for transfer via the accessory relay interface 492 to the accessory functional module 494 and/or to the control board 422 of the removable accessory 496. In some embodiments, the removable accessory 496 includes a battery 432 for local storage of power, while in other embodiments, the removable accessory 496 does not include a battery 432. The removable accessory 496 further includes wireless charging circuitry 430 that can be used to receive wireless power, e.g., from the wireless device 102 and/or from an external wireless charging pad (not shown). The wireless power received via the wireless charging circuitry 430 can be used to power modules of the removable accessory 496, including the accessory functional module 494, as well as the control board 422, the accessory relay interface 492, the second wireless protocol controller 488-B, the second wireless protocol antenna 486-B, the first wireless protocol controller 488-A, and the first wireless protocol antenna 486-A. When the removable accessory 496 includes a battery 432, the wireless charging circuitry 430 can receive and transfer power to the battery 432 for storage and subsequent use when wireless power transfer is not available.

The wireless device 102 and the removable accessory 496 can use the first wireless protocol interface transfer of encapsulated packets for secure pairing and the second wireless protocol interface for wireless data transfer of encapsulated data, e.g., encapsulated APDUs. Secure pairing of the wireless device 102 with the removable accessory 496 can be initiated during an initial power up procedure. In some embodiments, e.g., where the wireless communication protocol includes NFC, pairing via NFC can use a secure pairing and key exchange (SPAKE) protocol, e.g., SPAKE2+. In some embodiments, pairing via the wireless communication protocol can use a temporary pairing (TNEP) protocol. In some embodiments information from the accessory functional module can be used to derive pairing data. Pairing of the wireless device 102 with the removable accessory 496 can persist until a configuration of the accessory functional module 494 changes.

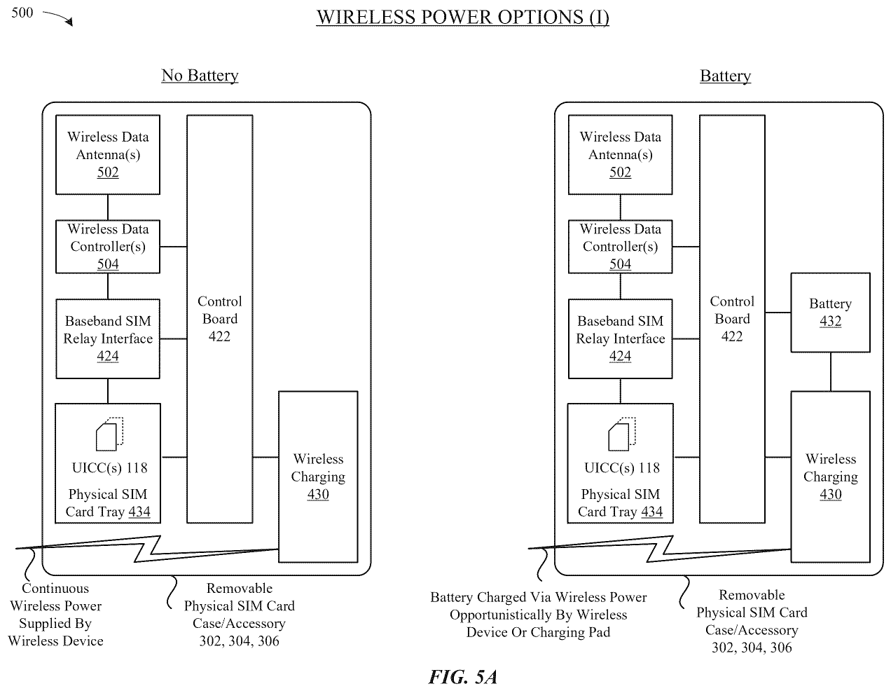

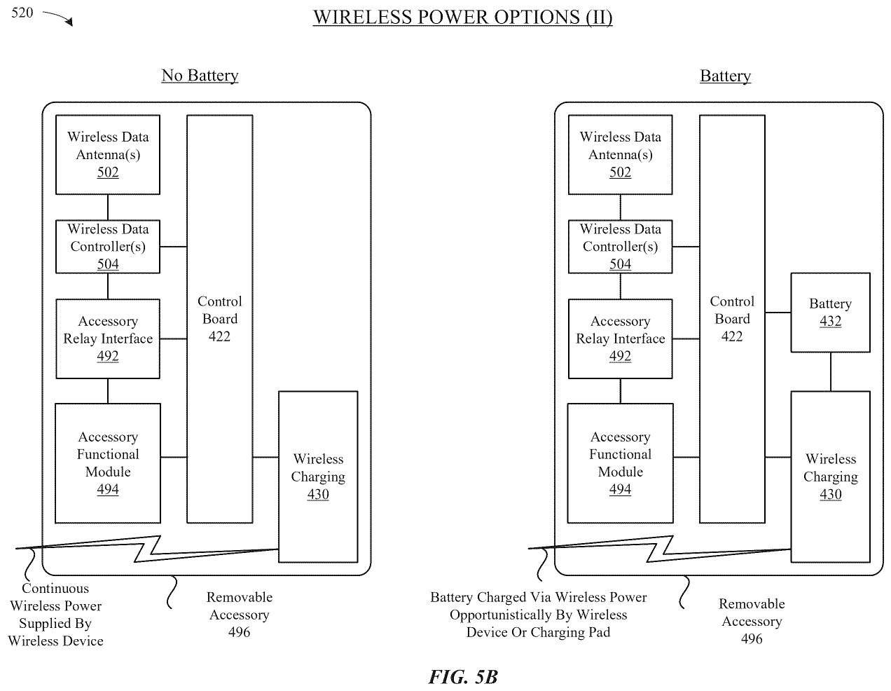

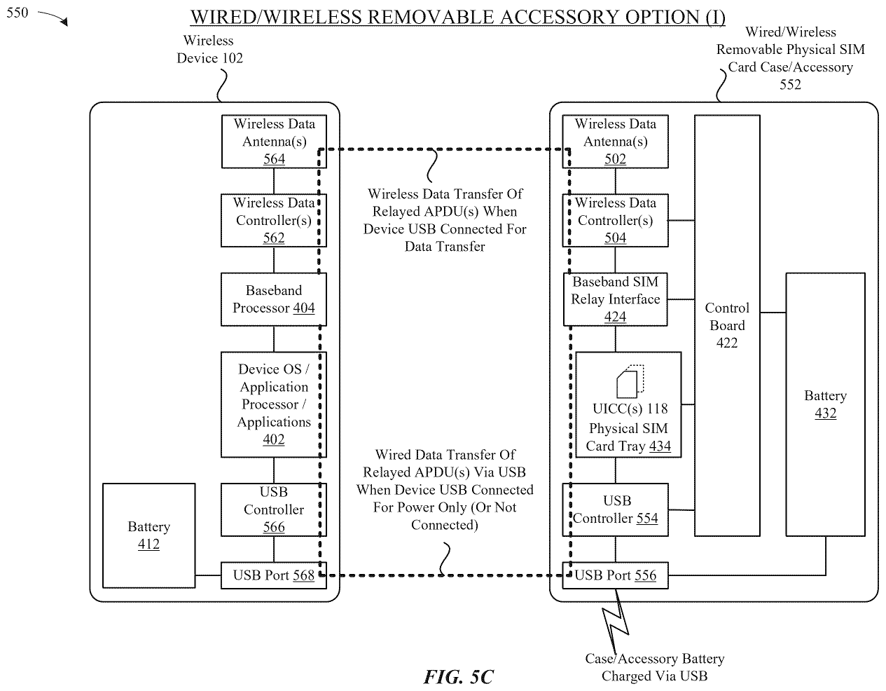

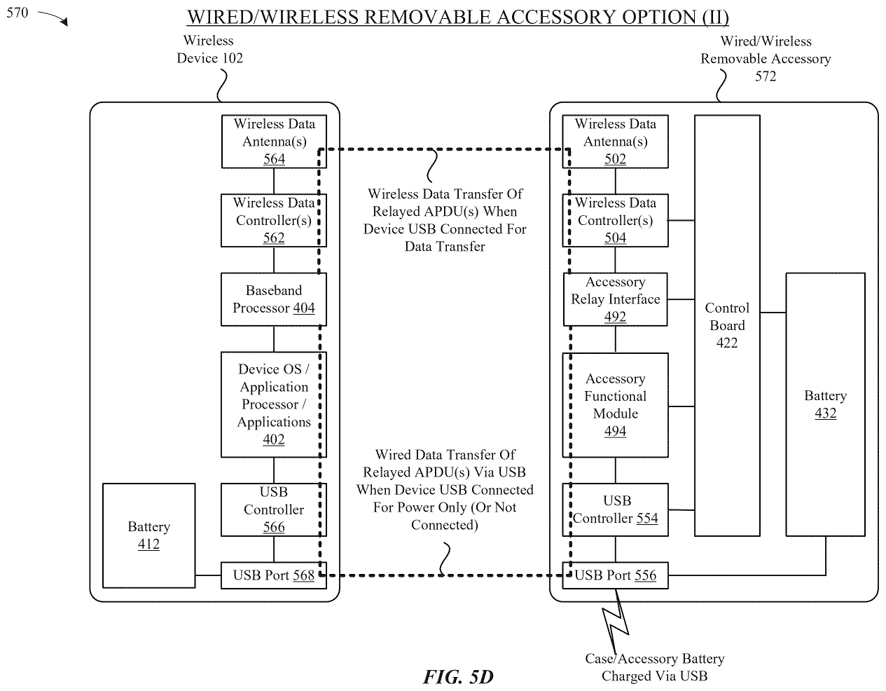

FIG. 5A illustrates a diagram 500 of exemplary wireless power options for a removable pSIM card case/accessory 302, 304, 306. In some cases, the removable pSIM card case/accessory 302, 304, 306 includes a battery 432 that can be charged via wireless charging circuitry 430, e.g., from wireless device 102 with which the removable pSIM card case/accessory is paired or from an external wireless charging pad. Wireless charging of the battery 432 can occur opportunistically and can be managed by circuitry of the removable pSIM card case/accessory 302, 304, 306. In some cases, wireless charging is managed to ensure that wireless charging of a wireless device 102 that is coupled to the removable pSIM card case/accessory 302, 304, 306 and wireless charging of the removable pSIM card case/accessory 302, 304, 306 do not interfere with each other. For example, wireless charging of the removable pSIM card case/accessory 302, 304, 306 can be prioritized, when needed, over wireless charging of the wireless device 102 to ensure that sufficient wireless power is available to maintain power to the pSIM card(s) 118 in the pSIM card tray 434. In some cases, wireless charging via an external wireless charging pad can be shared between the wireless device 102 and the removable pSIM card case/accessory 302, 304, 306, e.g., via a time-division protocol described further herein. A small battery in the removable pSIM card case/accessory 302, 304, 306 can be used to provide consistent and continuous power to the pSIM card 118 and other components of the removable pSIM card case/accessory 302, 304, 306 and can allow for interruptions of wireless power transfer between the wireless device 102 and the removable pSIM card case/accessory 302, 304, 306.

In some cases, the removable pSIM card case/accessory 302, 304, 306 does not include a battery, and continuous wireless power for the circuitry of the removable pSIM card case/accessory 302, 304, 306 is supplied by the wireless device 102 to which the removable pSIM card case/accessory 302, 304, 306 is coupled. Wireless charging circuitry 430 of the removable pSIM card case/accessory 302, 304, 306 can negotiate with and initiate wireless charging when paired with the wireless device 102. Without a battery, continuous power from the wireless device 102 can be required. In some cases, separate wireless power charging coils are used independently to ensure power without interruption, e.g., a primary wireless power charging coil of the wireless device 102 is used to charge the battery of the wireless device 102 and a secondary wireless power charging coil of the wireless device 102 is used to continuously provide power to the removable pSIM card case/accessory 302, 304, 306.

FIG. 5B illustrates a diagram 520 of exemplary wireless power supply options for a removable accessory 496. In some cases, the removable accessory 496 includes a battery 432 that can be charged via wireless charging circuitry 430, e.g., from wireless device 102 with which the removable accessory 496 is paired or from an external wireless charging pad. Wireless charging of the battery 432 can occur opportunistically and can be managed by circuitry of the removable accessory 496. In some cases, wireless charging is managed to ensure that wireless charging of a wireless device 102 that is coupled to the removable accessory 496 and wireless charging of the removable accessory 496 do not interfere with each other. For example, wireless charging of the removable accessory 496 can be prioritized, when needed, over wireless charging of the wireless device 102 to ensure that sufficient wireless power is available to maintain power to one or more modules of the removable accessory 496, to an accessory functional module 494, to ensure one or more functions of the removable accessory 496 continue to operate properly. In some cases, wireless charging via an external wireless charging pad can be shared between the wireless device 102 and the removable accessory 496, e.g., via a time-division protocol described further herein. A small battery in the removable accessory 496 can be used to provide consistent and continuous power to one or more modules of the removable accessory 496, e.g., to the accessory functional module 494, to support functions provided by the removable accessory 496 and can accommodate interruptions of wireless power transfer between the wireless device 102 and the removable accessory 496.

In some cases, the removable accessory 496 does not include a battery, and continuous wireless power for the circuitry of the removable accessory 496 is supplied by the wireless device 102 to which the removable accessory 496 is coupled. Wireless charging circuitry 430 of the removable accessory 496 can negotiate with and initiate wireless charging when paired with the wireless device 102. Without a battery, continuous power from the wireless device 102 can be required. In some cases, separate wireless power charging coils are used independently to ensure power without interruption, e.g., a primary wireless power charging coil of the wireless device 102 is used to charge the battery of the wireless device 102 and a secondary wireless power charging coil of the wireless device 102 is used to continuously provide power to the removable accessory 496.

FIG. 5C illustrates a diagram 550 of an exemplary wired power option for a wired/wireless pSIM card case/accessory 552. The wired/wireless pSIM card case/accessory 552 includes a battery 432, which can be charged via a wired universal serial bus (USB) connection through a USB port 556. The wired/wireless pSIM card case/accessory 552 further includes a USB controller 554 that connects the USB port 556 to the pSIM card tray 434 that houses one or more pSIM cards 118 (UICCs 118). In some cases, wireless power provided to the wireless device 102 can be supplied via a wired connection from the wireless device 102 to the battery 432 of the wired/wireless pSIM card case/accessory 552, e.g., via a USB port 568 of the wireless device 102 to the USB port 556 of the wired/wireless pSIM card case/accessory 552. In some cases, a USB connection between the wireless device 102 and the wired/wireless pSIM card case/accessory 552 can be used to transfer data, e.g., APDUs relayed from the baseband processor 404 of the wireless device 102 and the baseband SIM relay interface 424 of the wired/wireless pSIM card case/accessory 552. In some embodiments, data transfer via the USB connection can be limited to occur only when the wireless device 102 is not using the USB interface (USB controller 566 and USB port 568) for USB data communication with another device, for example when connected via USB for power only or not connected (except to the wired/wireless pSIM card case/accessory 552). When the USB interface of the wireless device 102 is used for data communication (other than to the wired/wireless pSIM card case/accessory 552), APDUs of the baseband processor 404 can be relayed via a separate wireless connection, e.g., using one or more wireless data controllers 562 connected to one or more wireless data antennas 564 (e.g., as described for the wireless options of any of FIGS. 4A to 4E), to one or more wireless data antennas 502 connected to one or more wireless data controllers 504 of the wired/wireless pSIM card case/accessory 552. A pass-through USB power connector of the wireless device and of the wired/wireless pSIM card case/accessory 552 is not impacted, as the USB connection between the wireless device 102 and the wired/wireless pSIM card case/accessory 552 is only used for data relaying when the USB port 568 is not otherwise connected or is connected for pass-through power only (and not for data from an external device). When the USB connection is in use, one or more wireless data protocols and associated wireless circuitry can be used to relay APDUs between the wireless device 102 and the wired/wireless pSIM card case/accessory 552.

FIG. 5D illustrates a diagram 570 of an exemplary wired power option for a wired/wireless removable accessory 572. The wired/wireless removable accessory 572 includes a battery 432, which can be charged via a wired universal serial bus (USB) connection through a USB port 556. The wired/wireless removable accessory 572 further includes a USB controller 554 that connects the USB port 556 to the accessory functional module 494, which can provide one or more functions for the wired/wireless removable accessory 572. In some cases, wireless power received by the wireless device 102 can be supplied to the battery 432 of the wired/wireless removable accessory 572 via a wired connection from the wireless device 102 to the wired/wireless removable accessory 572, e.g., via a USB port 568 of the wireless device 102 to the USB port 556 of the wired/wireless removable accessory 572. In some cases, a USB connection between the wireless device 102 and the wired/wireless removable accessory 572 can be used to transfer data, e.g., APDUs relayed from the baseband processor 404 of the wireless device 102 and the accessory relay interface 492 of the wired/wireless removable accessory 572. In some embodiments, data transfer via the USB connection can be limited to occur only when the wireless device 102 is not using the USB interface (USB controller 566 and USB port 568) for USB data communication with another device, for example when connected via USB for power only or not connected (except to the wired/wireless removable accessory 572). When the USB interface of the wireless device 102 is used for data communication (other than to the wired/wireless removable accessory 572), APDUs of the baseband processor 404 can be relayed via a separate wireless connection, e.g., using one or more wireless data controllers 562 connected to one or more wireless data antennas 564 (e.g., as described for the wireless options of any of FIGS. 4F and 4G), to one or more wireless data antennas 502 connected to one or more wireless data controllers 504 of the wired/wireless removable accessory 572. A pass-through USB power connector of the wireless device 102 and of the wired/wireless removable accessory 572 is not impacted, as the USB connection between the wireless device 102 and the wired/wireless removable accessory 572 is only used for data relaying when the USB port 568 is not otherwise connected or is connected for pass-through power only (and not for data from an external device). When the USB connection is in use, one or more wireless data protocols and associated wireless circuitry can be used to relay APDUs between the wireless device 102 and the wired/wireless removable accessory 572.

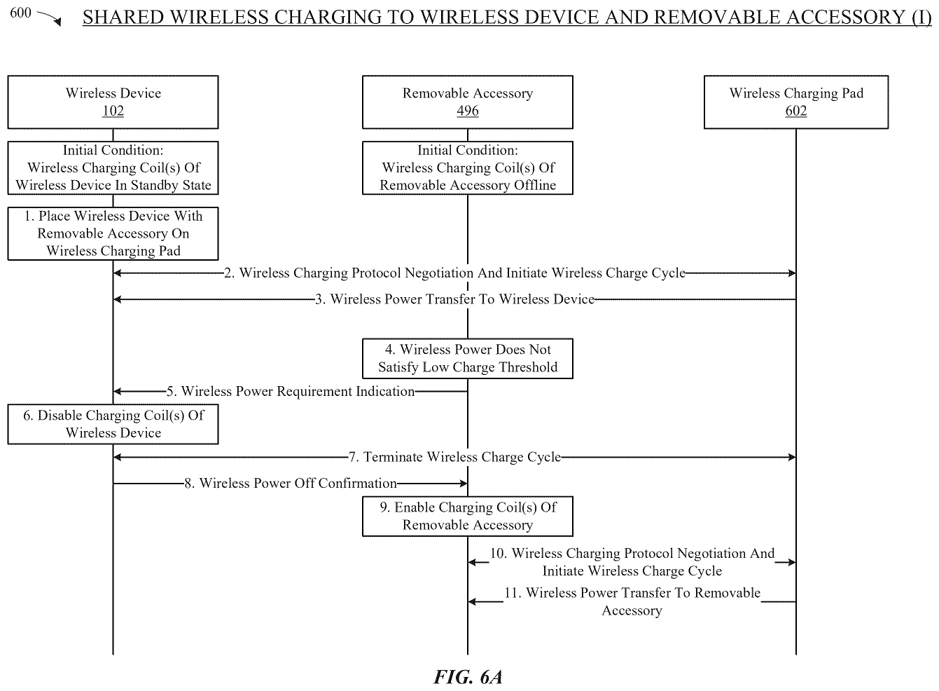

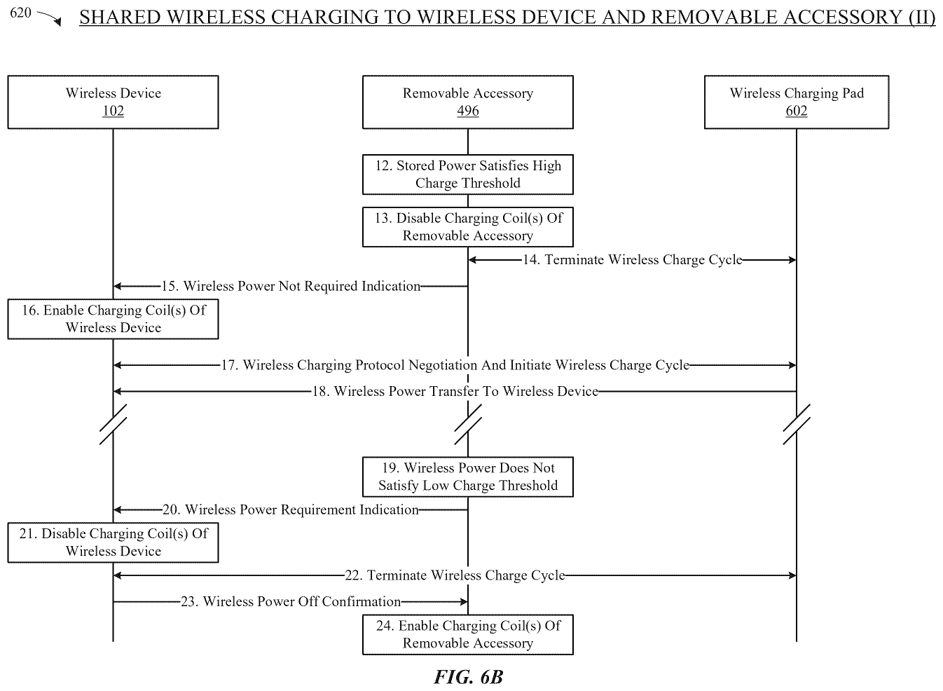

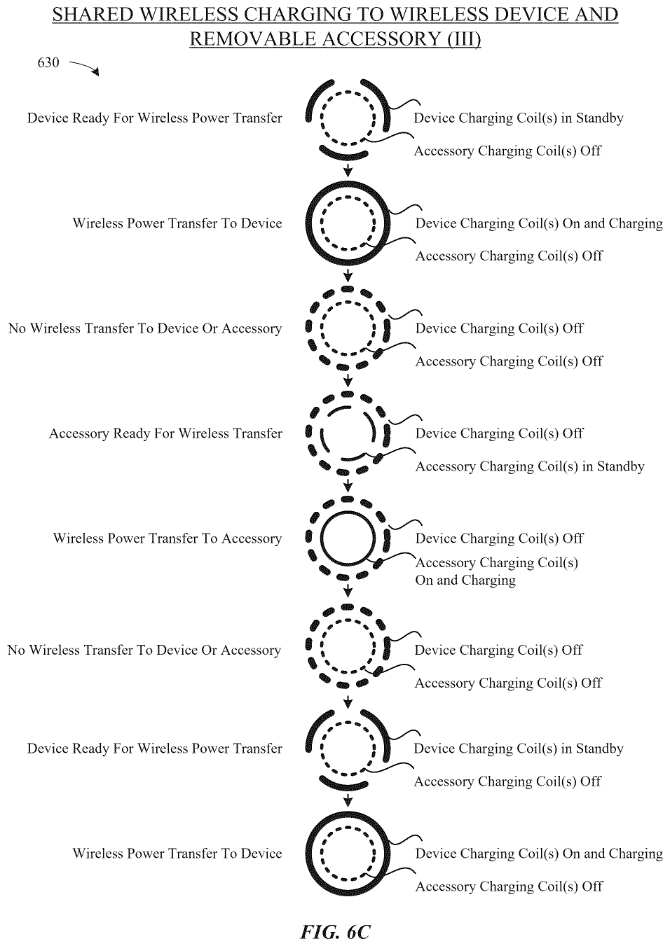

FIGS. 6A and 6B illustrates flow diagrams 600, 620 of exemplary process to allow shared wireless charging via a wireless charging pad 602 for a removable accessory 496 coupled to a wireless device 102. Initially, wireless charging coil(s) of the wireless device 102 can be in a standby state, while wireless charging coil(s) of the removable accessory 496 can be in an offline state. At a first step, the wireless device 102, which is coupled to the removable accessory 496 (e.g., pairing already completed and communication between the wireless device 102 and the removable accessory 496 possible), is placed on the wireless charging pad 602. At a second step, the wireless device 102 performs a wireless charging protocol negotiation procedure with the wireless charging pad 602 and subsequently initiates a wireless charge cycle for the wireless device 102. At a third step, wireless power is transferred from the wireless charging pad 602 to the wireless device 102, e.g., to charge a battery of the wireless device 102. At a fourth step, the removable accessory 496 determines that wireless power available for the removable accessory 496 does not satisfy a low charge threshold, e.g., stored power in a battery of the removable accessory 496 falls below a low charge threshold level. At a fifth step, the removable accessory 496 sends to the wireless device 102 a message that indicates the removable accessory 496 requires wireless power to be supplied. At a sixth step, the wireless device 102 disables wireless charging coil(s) of the wireless device 102. At a seventh step, the wireless device 102 terminates the wireless charge cycle with the wireless charging pad 602. At an eighth step, the wireless device 102 sends to the removable accessory 496 a reply message indicating that wireless power transfer to the wireless device 102 is off (and thereby indicating that wireless power transfer to the removable accessory 496 is permitted and may not interfere with wireless charging of the wireless device 102). At a ninth step, the removable accessory 496 enables wireless charging coils of the removable accessory 496. At a tenth step, the removable accessory 496 performs a wireless charging protocol negotiation procedure with the wireless charging pad 602 and subsequently initiates a wireless charge cycle for the removable accessory 496. At an eleventh step, wireless power is transferred from the wireless charging pad to the removable accessory 496, e.g., to charge a battery of the removable accessory 496. At a twelfth step, the removable accessory 496 determines that stored power of the removable accessory 496 satisfies a high charge threshold, e.g., stored power in a battery of the removable accessory 496 meets or exceeds a high charge threshold level. At a thirteenth step, the removable accessory 496 disables the wireless charging coil(s) of the removable accessory 496. At a fourteenth step, the removable accessory 496 terminates the wireless charge cycle with the wireless charging pad 602. At a fifteenth step, the removable accessory 496 sends to the wireless device 102 a second message indicating that wireless power for the removable accessory 496 is no longer required (and thereby indicating that wireless power transfer to the wireless device 102 is permitted). At a sixteenth step, the wireless device 102 re-enables wireless charging coils of the wireless device 102. At a seventeenth step, the wireless device 102 re-performs the wireless charging protocol negotiation procedure with the wireless charging pad 602 and subsequently initiates a new wireless charge cycle for the wireless device 102. At an eighteenth step, wireless power is transferred from the wireless charging pad 602 to the wireless device 102, e.g., to charge the battery of the wireless device 102.

At a subsequent time period, e.g., after stored power of the removable accessory 496 has been depleted to a certain level, at a nineteenth step, the removable accessory 496 determines that wireless power available for the removable accessory 496 again does not satisfy a low charge threshold, e.g., stored power in a battery of the removable accessory 496 falls below the low charge threshold level. At a twentieth step, the removable accessory 496 again sends to the wireless device 102 a message that indicates the removable accessory 496 requires wireless power to be supplied. At a twenty-first step, the wireless device 102 disables wireless charging coil(s) of the wireless device 102. At a twenty-second step, the wireless device 102 terminates an ongoing wireless charge cycle with the wireless charging pad 602. At a twenty-third step, the wireless device 102 sends to the removable accessory 496 a second reply message indicating that wireless power transfer to the wireless device 102 is off (and thereby indicating that wireless power transfer to the removable accessory 496 is permitted and may not interfere with wireless charging of the wireless device 102). At a twenty-fourth step, the removable accessory 496 enables wireless charging coils of the removable accessory 496 to allow for wireless charging of the battery of the removable accessory 496. As shown in FIGS. 6A and 6B, wireless power transfer from the wireless charging pad 602 can be shared between the wireless device 102 and the removable accessory 496 using a coordinated sharing power transfer sharing procedure. An exemplary removable accessory 496 can include a removable pSIM card case/accessory 302, 304, 306 as described herein.

FIG. 6C illustrates a sequence diagram 630 of various states of wireless charging coils for a removable accessory 496 and for a wireless device 102 when performing shared wireless charging. Initially, the wireless device 102 can be ready for wireless power transfer, with wireless charging coil(s) of the wireless device 102 in a standby state, while wireless charging coils of the removable accessory 496 can be in an off state. Subsequently, when wireless power transfer to the wireless device 102 occurs, the wireless charging coils of the wireless device 102 can be in an on state while the wireless charging coils of the removable accessory 496 can continue in the off state. In preparation for subsequent wireless charging to the removable accessory 496, (in place of wireless charging to the wireless device 102) the wireless charging coils of the wireless device 102 can be turned off, while the wireless charging coils of the removable accessory 496 can continue in the off state. In this state (both wireless charging coils in the off state) no wireless power transfer occurs to the wireless device 102 or to the removable accessory 496. Subsequently, readying the removable accessory 496 for wireless power transfer, the wireless charging coils of the removable accessory 496 are placed in the standby state, while the device charging coils of the wireless device 102 remain in the off state. Then, the wireless charging coils of the removable accessory 496 are placed in the on state and wireless power transfer to the removable accessory 496 via the wireless charging coils occurs. The wireless charging coils of the wireless device 102 remain in the off state while wireless charging of the removable accessory 496 occurs. After wireless power transfer to the removable accessory 496 completes, the wireless charging coils of the removable accessory 496 are placed in the off state, while the wireless charging coils of the wireless device 102 remain in the off state. In this state (both wireless charging coils in the off state) no wireless power transfer occurs to the wireless device 102 or to the removable accessory 496. Subsequently, readying the wireless device 102 for wireless power transfer, the wireless charging coils of the wireless device 102 are placed in the standby state, while the device charging coils of the removable accessory 496 remain in the off state. Then, the wireless charging coils of the wireless device 102 are placed in the on state and wireless power transfer to the wireless device 102 via the wireless charging coils occurs. An exemplary removable accessory 496 can include a removable pSIM card case/accessory 302, 304, 306 as described herein.

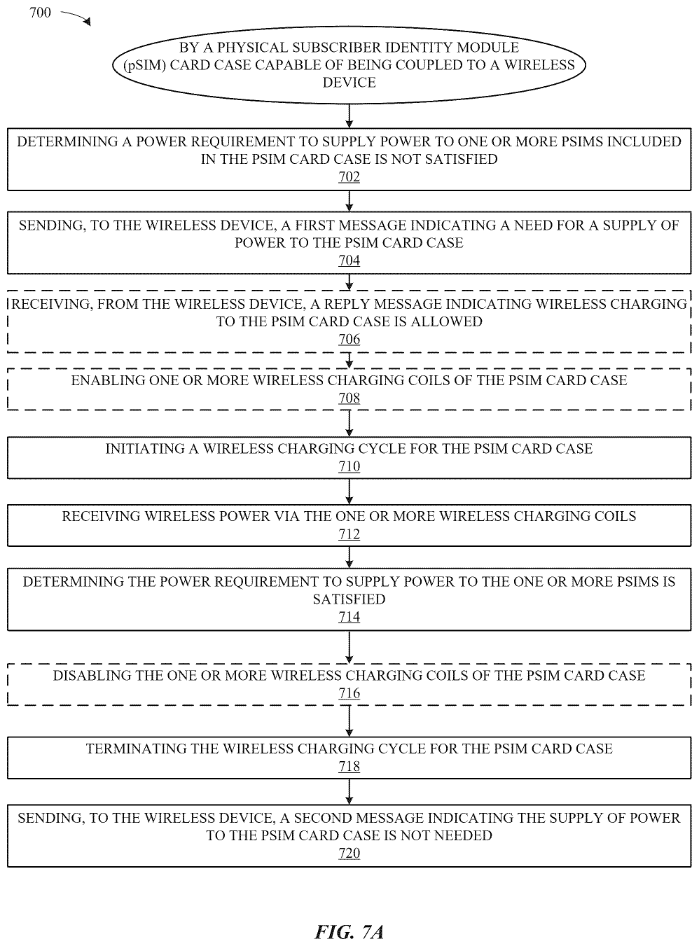

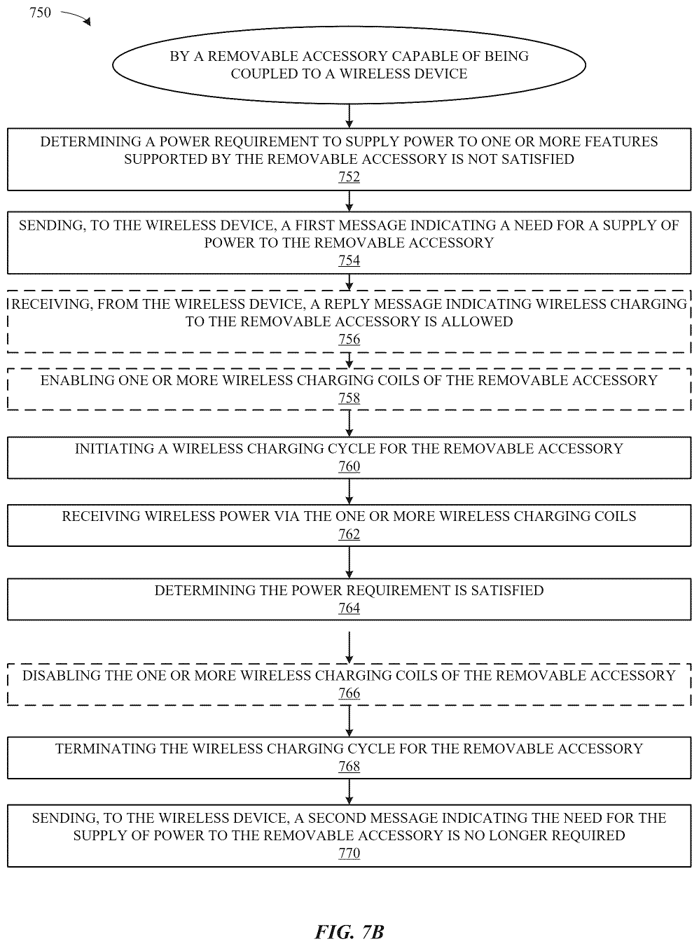

FIG. 7 illustrates a flowchart 700 of an exemplary method performed by a pSIM card case 302, 304 that is capable of being coupled to a wireless device 102 to manage wireless charging of the pSIM card case 302, 304. At 702, the pSIM card case 302, 304 determines a power requirement to supply power to one or more pSIMs 118 included in the pSIM card case 302, 304 is not satisfied. At 704, the pSIM card case 302, 304 sends, to the wireless device 102, a first message indicating a need for a supply of power to the pSIM card case 302, 304. In an optional aspect, at 706, the pSIM card case 302, 304 can receive, from the wireless device 102 after sending the first message indicating the need for the supply of power to the pSIM card case 302, 304, a reply message indicating wireless charging to the pSIM card case 302, 304 is allowed. In an optional aspect, at 708, the pSIM card case 302, 304 can enable one or more wireless charging coils of the pSIM card case 302, 304 after receipt of the reply message indicating wireless charging to the pSIM card case 302, 304 is allowed. At 710, the pSIM card case 302, 304 initiates a wireless charging cycle for the pSIM card case 302, 304. At 712, the pSIM card case 302, 304 receives wireless power via the one or more wireless charging coils. At 714, the pSIM card case 302, 304 determines the power requirement to supply power to the one or more pSIMs 118 is satisfied. In an optional aspect, at 716, the pSIM card case 302, 304 can disable the one or more wireless charging coils of the pSIM card case 302, 304 after determining the power requirement to supply power to the one or more pSIMs is satisfied. At 718, the pSIM card case 302, 304 terminates the wireless charging cycle for the pSIM card case 302, 304. At 720, the pSIM card case 302, 304, sends, to the wireless device 102, a second message indicating the supply of power to the pSIM card case 302, 304 is not needed.

In some embodiments, the pSIM card case 302, 304 receives the wireless power from the wireless device 102. In some embodiments, the method performed by the pSIM card case 302, 304 further includes the pSIM card case 302, 304 performing a wireless charging protocol negotiation procedure with the wireless device 102 prior to initiation of the wireless charging cycle. In some embodiments, the pSIM card case 302, 304 performs a wireless charging protocol negotiation procedure with the wireless device 102 prior to initiation of any wireless charging cycle between the pSIM card case 302, 304 and the wireless device 102. In some embodiments, the pSIM card case 302, 304 receives the wireless power from a wireless charging pad 602 external to the wireless device 102. In some embodiments, the method performed by the pSIM card case 302, 304 further includes the pSIM card case 302, 304 performing a wireless charging protocol negotiation procedure with the wireless charging pad 602 prior to initiating the wireless charging cycle. In some embodiments, the pSIM card case 302, 304 includes a battery 432, and the power requirement is not satisfied when a stored power level of the battery 432 does not satisfy a power threshold. In some embodiments, one or more wireless charging coils of the wireless device 102 are disabled after transmission of the first message from the pSIM card case 302, 304 to the wireless device 102. In some embodiments, the one or more wireless charging coils of the wireless device 102 are enabled after transmission of the second message from the pSIM card case 302, 304 to the wireless device 102.

While the method described in FIG. 7A regards a pSIM card case 302, 304 capable of being coupled to a wireless device 102, a comparable method can be performed by an external accessory, e.g., a removable accessory 496, which is capable of being coupled to a battery powered device, e.g., a wireless device 102. The same, or a similar set of steps, can be performed by the external in communication with a battery powered device based on a power requirement for the external accessory not being satisfied and the battery powered device being able to provide wireless power to the external accessory with appropriate negotiation and execution of a wireless charging protocol between the external accessory and the battery powered device.

FIG. 7B illustrates a flowchart 750 of an exemplary method performed by a removable accessory 496 that is capable of being coupled to a wireless device 102 to manage wireless charging of the removable accessory 496. At 752, the removable accessory 496 determines a power requirement to supply power to one or more features supported by the removable accessory 496 is not satisfied. At 754, the removable accessory 496 sends, to the wireless device 102, a first message indicating a need for a supply of power to the removable accessory 496. In an optional aspect, at 756, the removable accessory 496 can receive, from the wireless device 102 after sending the first message indicating the need for the supply of power to the removable accessory 496, a reply message indicating wireless charging to the removable accessory 496 is allowed. In an optional aspect, at 758, the removable accessory 496 can enable one or more wireless charging coils of the removable accessory 496 after receipt of the reply message indicating wireless charging to the removable accessory 496 is allowed. At 760, the removable accessory 496 initiates a wireless charging cycle for the removable accessory 496. At 762, the removable accessory 496 receives wireless power via the one or more wireless charging coils. At 764, the removable accessory 496 determines the power requirement is satisfied. In an optional aspect, at 766, the removable accessory 496 can disable the one or more wireless charging coils of the removable accessory 496 after determining the power requirement is satisfied. At 768, the removable accessory 496 terminates the wireless charging cycle for the removable accessory 496. At 770, the removable accessory 496, sends, to the wireless device 102, a second message indicating the supply of power to the removable accessory 496 is not needed.

In some embodiments, the removable accessory 496 receives the wireless power from the wireless device 102. In some embodiments, the method performed by the removable accessory 496 further includes the removable accessory 496 performing a wireless charging protocol negotiation procedure with the wireless device 102 prior to initiation of the wireless charging cycle. In some embodiments, the removable accessory 496 performs a wireless charging protocol negotiation procedure with the wireless device 102 prior to initiation of any wireless charging cycle between the removable accessory 496 and the wireless device 102. In some embodiments, the removable accessory 496 receives the wireless power from a wireless charging pad 602 external to the wireless device 102. In some embodiments, the method performed by the removable accessory 496 further includes the removable accessory 496 performing a wireless charging protocol negotiation procedure with the wireless charging pad 602 prior to initiating the wireless charging cycle. In some embodiments, the removable accessory 496 includes a battery 432, and the power requirement is not satisfied when a stored power level of the battery 432 does not satisfy a power threshold. In some embodiments, the first message prompts the wireless device to disable one or more wireless charging coils. In some embodiments, the second message prompts the wireless device 102 to enable one or more wireless charging coils.

### Representative Device

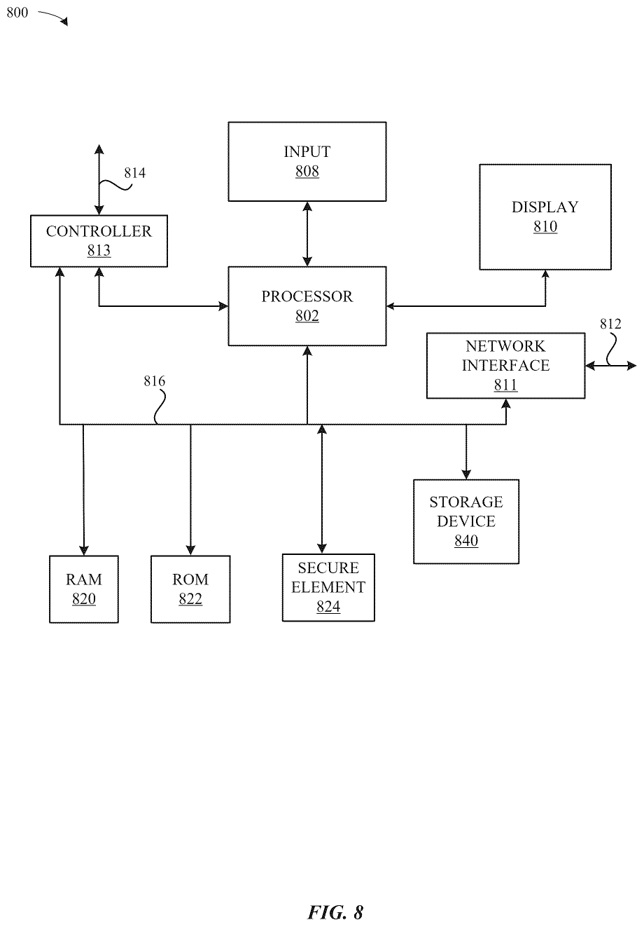

FIG. 8 illustrates a detailed view of a representative computing device 800 that can be used to implement various methods described herein, according to some embodiments. In particular, the detailed view illustrates various components that can be included in the wireless device 102. As shown in FIG. 8, the computing device 800 can include a processor 802 that represents a microprocessor or controller for controlling the overall operation of computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, etc. Still further, the computing device 800 can include a display 810 that can be controlled by the processor 802 to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that communicatively couples to a data link 812. In the case of a wireless connection, the network/bus interface 811 can include a wireless transceiver.

The computing device 800 also includes a storage device 840, which can comprise a single disk or a plurality of disks (e.g., hard drives), and includes a storage management module that manages one or more partitions within the storage device 840. In some embodiments, storage device 840 can include flash memory, semiconductor (solid state) memory or the like. The computing device 800 can also include a Random Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of the computing device 800. The computing device 800 can further include a secure element (SE) 824, which can represent secure storage for cellular wireless system access by the wireless device 102, such as an eUICC 108 on which to store one or more eSIMs 208 and/or a UICC 118 on which to store a pSIM profile.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for power management of a removable accessory capable of being coupled to a wireless device, the method comprising:
by the removable accessory:
determining a power requirement to supply power to one or more features supported by the removable accessory are not satisfied;
sending, to the wireless device, a first message indicating a need for a supply of power to the removable accessory;
initiating a wireless charging cycle for the removable accessory;
receiving wireless power via the one or more wireless charging coils;
determining the power requirement is satisfied;
terminating the wireless charging cycle for the removable accessory; and
sending, to the wireless device, a second message indicating the need for the supply of power to the removable accessory is no longer required.

2. The method of claim 1, wherein the removable accessory receives the wireless power from the wireless device.

3. The method of claim 2, further comprising:
performing, by the removable accessory, a wireless charging protocol negotiation procedure with the wireless device prior to initiating the wireless charging cycle.

4. The method of claim 1, wherein the removable accessory receives the wireless power from a wireless charging pad external to the wireless device.

5. The method of claim 4, further comprising:
performing, by the removable accessory, a wireless charging protocol negotiation procedure with the wireless charging pad prior to initiation of the wireless charging cycle.

6. The method of claim 1, wherein:
the removable accessory includes a battery; and
the power requirement is not satisfied when a stored power level of the battery is less than a power threshold.

7. The method of claim 1, wherein the first message prompts the wireless device to disable one or more wireless charging coils.

8. The method of claim 7, wherein the second message prompts the wireless device to re-enable the one or more wireless charging coils.

9. A removable accessory capable of being coupled to a wireless device, the removable accessory comprising circuitry configured to:
determine a power requirement to supply power to one or more features supported by the removable accessory are not satisfied;
send, to the wireless device, a first message indicating a need for a supply of power to the removable accessory;
initiate a wireless charging cycle for the removable accessory;
receive wireless power via one or more wireless charging coils;
determine the power requirement is satisfied;
terminate the wireless charging cycle for the removable accessory; and
send, to the wireless device, a second message indicating the need for the supply of power to the removable accessory is no longer required.

10. The removable accessory of claim 9, wherein the removable accessory receives the wireless power from the wireless device.

11. The removable accessory of claim 10, wherein the circuitry is further configured to:
perform a wireless charging protocol negotiation procedure with the wireless device prior to initiation of the wireless charging cycle.

12. The removable accessory of claim 9, wherein the removable accessory receives the wireless power from a wireless charging pad external to the wireless device.

13. The removable accessory of claim 12, wherein the circuitry is further configured to:
perform a wireless charging protocol negotiation procedure with the wireless charging pad prior to initiation of the wireless charging cycle.

14. The removable accessory of claim 9, wherein:
the removable accessory includes a battery; and
the power requirement is not satisfied when a stored power level of the battery is less than a power threshold.

15. The removable accessory of claim 9, wherein the first message prompts the wireless device to disable one or more wireless charging coils.

16. The removable accessory of claim 15, wherein the second message prompts the wireless device to re-enable the one or more wireless charging coils.

17. A non-transitory computer-readable storage medium storing instructions that configure a removable accessory capable of being coupled to a wireless device, to perform actions comprising:
determining a power requirement to supply power to one or more features supported by the removable accessory are not satisfied;
sending, to the wireless device, a first message indicating a need for a supply of power to the removable accessory;
initiating a wireless charging cycle for the removable accessory;
receiving wireless power via the one or more wireless charging coils;
determining the power requirement is satisfied;
terminating the wireless charging cycle for the removable accessory; and
sending, to the wireless device, a second message indicating the need for the supply of power to the removable accessory is no longer required.

18. The non-transitory computer-readable storage medium of claim 17, wherein:
the removable accessory receives the wireless power from a wireless charging pad external to the wireless device; and
the removable accessory is configured to perform a wireless charging protocol negotiation procedure with the wireless charging pad prior to initiation of the wireless charging cycle.

19. The non-transitory computer-readable storage medium of claim 17, wherein:
the removable accessory includes a battery; and
the power requirement is not satisfied when a stored power level of the battery is less than a power threshold.

20. The non-transitory computer-readable storage medium of claim 17, wherein:
the first message prompts the wireless device to disable one or more wireless charging coils; and
the second message prompts the wireless device to re-enable the one or more wireless charging coils.
